(19) United States
(12) Patent Application Publication
(10) Pub. No.: US 2026/0125100 A1
(43) Pub. Date: May 7, 2026

(54) COMPONENT FOR VEHICLE INTERIOR

(71) Applicant: Yanfeng International Automotive Technology Co., Ltd., Novi, MI (US)

(72) Inventors: Manfred Pohl, Pulheim (DE); Lucas Steffens, Neuss (DE); Holger Maul, Groß-Zimmern (DE)

(21) Appl. No.: 19/435,345

(22) Filed: Dec. 29, 2025

Related U.S. Application Data
(63) Continuation of application No. PCT/US2024/036271, filed on Jun. 28, 2024.
(60) Provisional application No. 63/524,288, filed on Jun. 30, 2023.

(51) Int. Cl. B62D 1/04

(52) U.S. Cl. CPC B62D 1/04

(57) ABSTRACT

A component/steering wheel for a vehicle may comprise a composite structure assembled to a frame comprising a cover, a functional insert and an interface for each functional insert. The interface may comprise an electrical interface/connection and a mechanical interface/connection; the interface may comprise a combined/integrated interface/connector comprising the electrical interface/connector and the mechanical interface/connector. The cover may comprise a set of cover/shell segments; the functional insert may comprise a set of functional insert segments; the composite structure may comprise a set of composite structure segments comprising the cover segments and functional insert segments. The interface may provide mechanical alignment of the shell segments and electrical connection of the functional insert segments. The functional insert may comprise a heating element, sensor and/or electrified functional insert. The functional insert may comprise a set of functional insert segments mechanically and electrically connected.

### CROSS-REFERENCE TO RELATED APPLICATIONS

The present application is a continuation of PCT/International Patent Application No. PCT/US2024/036271 titled “COMPONENT FOR VEHICLE INTERIOR” filed Jun. 28, 2024 which claims priority to U.S. Provisional Patent Application No. 63/524,288 titled “COMPONENT FOR VEHICLE INTERIOR” filed Jun. 30, 2023.

The present application claims priority to and incorporates by reference in full the following patent applications: (1) U.S. Provisional Patent Application No. 63/524,288 titled “COMPONENT FOR VEHICLE INTERIOR” filed Jun. 30, 2023; and (2) PCT/International Patent Application No. PCT/US2024/036271 titled “COMPONENT FOR VEHICLE INTERIOR” filed Jun. 28, 2024.

The present application relates to and incorporates by reference in full the following patent applications: (1) U.S. Provisional Patent Application No. 63/252,513 titled “VEHICLE INTERIOR COMPONENT” filed Oct. 14, 2021; (2) PCT/International Patent Application No. PCT/US2022/046625 titled “COMPONENT FOR VEHICLE INTERIOR” filed Oct. 13, 2022; (3) PCT/International Patent Application No. PCT/US2022/046626 titled “COMPONENT FOR VEHICLE INTERIOR” filed Oct. 13, 2022; (4) U.S. patent application Ser. No. 18/632,567 titled “COMPONENT FOR VEHICLE INTERIOR” filed Apr. 11, 2024; (5) U.S. patent application Ser. No. 18/632,618 titled “COMPONENT FOR VEHICLE INTERIOR” filed Apr. 11, 2024; (6) European Patent Application No. 22881804.3 titled “COMPONENT FOR VEHICLE INTERIOR” filed Apr. 9, 2024; (7) European Patent Application No. 22881805.0 titled “COMPONENT FOR VEHICLE INTERIOR” filed Apr. 12, 2024; (8) Chinese Patent Application No. 202280068107.2 titled “COMPONENT FOR VEHICLE INTERIOR” filed Apr. 9, 2024; and (9) Chinese Patent Application No. 202280068106.8 titled “COMPONENT FOR VEHICLE INTERIOR” filed Apr. 9, 2024.

### FIELD

The present invention relates to a component for a vehicle interior.

The present invention also relates to a component such as a steering wheel assembly for a vehicle interior comprising a set of segments.

### BACKGROUND

It is known to provide a component for a vehicle interior with a heating function and/or detection of contact.

It would be advantageous to provide an improved component for a vehicle interior comprising a composite structure that is configured for efficient assembly including mechanical/electrical connection of a functional element.

It would be advantageous to provide an improved component for a vehicle interior comprising a composite structure that is configured for efficient assembly including mechanical/electrical connection of a functional element with a combined/integrated connector arrangement.

It would be advantageous to provide a component for a vehicle interior that is configured with a composite structure comprising at least one segment that is configured for efficient assembly.

It would be advantageous to provide a component for a vehicle interior such as a steering wheel that is configured with a rim comprising a composite structure comprising at least one segment that is configured for efficient assembly.

It would be advantageous to provide a component for a vehicle interior such as a steering wheel that is configured with a rim comprising a composite structure comprising at least one segment comprising a functional insert/layer in the form of a heating element or hand-off detection sensor.

### SUMMARY

The present invention relates to a component for a vehicle interior comprising a steering wheel assembly comprising a frame and a composite structure configured to be assembled to the frame; the composite structure may comprise a cover and an insert; the insert may comprise a functional insert; the composite structure may comprise an interface for each functional insert; the interface may comprise an electrical interface and a mechanical interface for the functional insert; the composite structure may comprise a set of composite structure segments; the interface may be configured to provide mechanical alignment of the set of shell segments and electrical connection of the functional insert segments. The composite structure may comprise a set of composite structure segments comprising the set of cover segments and the set of functional insert segments; the composite structure may comprise a set of composite structure segments comprising the set of shell segments and the set of functional insert segments; the interface may comprise a combined interface for mechanical alignment and electrical connection. A functional insert may comprise a set of functional insert segments configured to be mechanically connected and electrically connected at a metal-to-metal press-fit connector provided at the interface. The interface may comprise at least one of (a) a connector; (b) a metal connector; (c) a terminal; (d) a plug; (e) a socket for a plug; (f) a plug for a socket; (g) a plug and a socket; (h) a conductor; (i) a conductor plate; (j) a metal plate; (k) a plastic connector. The interface may comprise (a) a bridge and a base; (b) an electrical connection at the bridge and a base; and (c) a mechanical connection at the bridge and a base; (d) a mechanical connector; (e) an electrical connector; (f) a conductor. The interface may comprise a mechanical connector; the mechanical connector may comprise an electrical interface; the electrical connector may comprise a mechanical interface. The interface may comprise a self-aligning mechanical connection comprising a plastic member at a bridge and a base and/or a self-aligning mechanical connection comprising a plug and a socket. The interface may comprise a connector; the connector may comprise a bridge; the bridge may comprise a conductor. The interface may comprise a connector; the connector may comprise a flexible element; the flexible element may comprise at least one of (a) a wire; (b) a rigid flexible wire; (c) a cable; (d) a semi-rigid wire; (e) a generally S-shaped element; (f) a generally S-shaped wire. The functional insert may comprise at least one of (a) a heating element; (b) a sensor; (c) a switch; (d) a functional circuit. The interface may comprise a connector; the connector may comprise at least one of (a) a wire; (b) a bridge; (c) an S-shaped wire element; (d) a flexible S-shaped wire element; (e) a bendable S-shaped wire element; (f) a twistable S-shaped wire element. The composite structure may comprise a set of cover segments of the cover and a set of functional insert segments of the functional insert; a functional insert segment of the functional insert is provided within a cover segment of the cover; the interface may comprise a connector configured to retain an electrical connection between adjacent functional insert segments during misalignment of adjacent cover segments. The cover segment may comprise at least one of (a) a recess for a connector for the interface; (b) a projection for a connector for the interface; (c) a surface for a connector for the interface; (d) a mount for a connector for the interface. The composite structure may comprise a carrier; the carrier may comprise at least one of (a) a set of carrier segments; (b) a plastic material; (c) a rigid material; (d) a rigid plastic material. The composite structure may comprise a base configured to provide alignment for the functional insert.

The present invention relates to a component for a vehicle interior comprising a base and a composite structure configured to be assembled to the base; the composite structure may comprise a cover and a functional insert; the composite structure may comprise an interface for the functional insert; the interface may comprise a mechanical interface and an electrical interface for the functional insert.

The present invention relates to a component for a vehicle interior comprising a steering wheel assembly comprising a frame and a composite structure configured to be assembled to the frame; the composite structure may comprise a cover and a functional insert; the composite structure may comprise an interface for each functional insert; the interface may comprise an electrical interface and a mechanical interface for the functional insert. The interface may comprise an integrated connector comprising the electrical interface and the mechanical interface for the functional insert; the cover may comprise a set of cover segments. The composite structure may comprise a set of composite structure segments; the composite structure may comprise a set of composite structure segments comprising the set of cover segments and the set of functional insert segments; the composite structure may comprise a set of composite structure segments comprising the set of shell segments and the set of functional insert segments. The interface may be configured to provide mechanical alignment of the set of shell segments and electrical connection of the functional insert segments; the interface may comprise a combined interface for mechanical alignment and electrical connection; a functional insert is configured to be electrified; the functional insert is configured to provide a functional circuit; the functional insert may comprise a set of functional insert segments configured to be mechanically connected and electrically connected at a connector provided at the interface; the functional insert may comprise a set of functional insert segments; the interface is configured to be mechanically connected and electrically connected at a connector between functional inserts; the functional insert may comprise a set of functional insert segments configured to be mechanically connected and electrically connected at a connector comprising a wire connection provided at the interface; the functional insert may comprise a set of functional insert segments configured to be mechanically connected and electrically connected at a metal-to-metal press-fit connector provided at the interface; the functional insert may comprise a set of functional insert segments configured to be mechanically connected and electrically connected at a combined connector provided at the interface; the functional insert may comprise a set of functional insert segments. The interface is configured to connect each functional insert segment. Each functional insert segment may be configured to be connected at a segment interface; the segment interface may comprise an integrated connector comprising a mechanical interface and an electrical interface for the functional insert segment. The interface may comprise the segment interface; the segment interface may comprise the mechanical interface and the electrical interface and a connector; the interface may comprise at least one of a connector and/or a metal connector and/or a terminal and/or a plug and/or a socket for a plug and/or a plug for a socket and/or a plug and a socket and/or a conductor and/or a conductor plate and/or a metal plate and/or a plastic connector; the interface may comprise a bridge and a base and/or an electrical connection at the bridge and a base; and a mechanical connection at the bridge and a base and/or a mechanical connector and/or an electrical connector and/or a conductor. The mechanical connector may comprise an electrical interface; the electrical connector may comprise a mechanical interface. The interface may comprise a self-aligning mechanical connection; the interface may comprise a mechanical connection comprising a plastic member at a bridge and a base; the interface may comprise a self-aligning mechanical connection comprising a plastic member at a bridge and a base and/or a self-aligning mechanical connection comprising a plug and a socket; the interface may comprise a self-aligning mechanical connection comprising a plug and a socket configured to align adjacent composite structure segments; the interface may comprise at least one of a press-fit electrical interface and/or a press-fit electrical connector and/or a plug electrical interface and/or a plug electrical connector and/or a plug-in electrical interface and/or a plug-in electrical connector and/or a plug-socket electrical interface and/or a plug-socket electrical connector and/or interference fit and/or friction fit; and/or force fit. The connector may comprise a bridge; the bridge may comprise a conductor; the connector may comprise a flexible element; the flexible element may comprise at least one of a wire and/or a rigid flexible wire and/or a cable and/or a semi-rigid wire and/or a generally S-shaped element and/or a generally S-shaped wire. The wire may comprise at least one of a flexible insulated wire configured to fit into a connector base and/or a semi-rigid flexible insulated wire configured to fit into a connector base and/or a semi-rigid flexible insulated wire configured to fit at each end into a connector base and/or a semi-rigid flexible insulated wire configured to fit at each end into a slot in a connector base and/or a semi-rigid flexible insulated wire configured to fit at each end into a slot in a connector base to form an electrical connection for the interface and/or an insulated wire fit into a connector comprising an insulation displacement connector. The connector may comprise a connector base; the connector may comprise at least one of a connector element and/or a set of connectors and/or a jumper and/or an extension and/or a plate. The functional insert may comprise at least one of a heating element and/or a sensor and/or a switch and/or a functional circuit; the functional circuit may comprise a sensor; a hands-off sensor; and/or a hands-on sensor. The sensor may comprise a capacitive sensor. The functional circuit may comprise a switch; the switch may comprise a transistor; the transistor may comprise a metal-oxide-semiconductor field-effect transistor. The functional insert may comprise at least one of a layer and/or a mat and/or a film and/or a foil and/or a molded material and/or a single layer material and/or a multi-layer material and/or a fabric material and/or a set of wires and/or a set of wires in a molded material and/or a set of sections; the functional insert may comprise a connector; a functional insert segment may comprise a combined interface with a connector for the electrical interface and for the mechanical interface. The composite structure may comprise a set of cover segments of the cover and a set of functional insert segments of the functional insert; a functional insert segment of the functional insert is provided within a cover segment of the cover; the interface may comprise a connector configured to retain an electrical connection between adjacent functional insert segments during misalignment of adjacent cover segments. The connector may comprise at least one of a wire and/or a bridge and/or an S-shaped wire element and/or a flexible S-shaped wire element and/or a bendable S-shaped wire element and/or a twistable S-shaped wire element. The cover may comprise a set of cover segments comprising a cover material; the cover material may comprise at least one of a resin, a plastic, a film, leather, synthetic leather, a fabric, a textile, a cork material, a sustainable leather alternative material, a molded cover material, a wrap, a wrappable material, a drapable material, a flexible cover material. A cover segment may comprise at least one of a recess for a connector for the interface and/or a projection for a connector for the interface and/or a surface for a connector for the interface and/or a mount for a connector for the interface. The composite structure may comprise a base and/or a substrate for a functional layer of the functional insert. The composite structure may comprise a carrier; the carrier may comprise at least one of a set of carrier segments and/or a plastic material and/or a rigid material and/or a rigid plastic material. The base is configured to provide alignment for the functional insert. The intermediate layer may comprise at least one of a spacer, a spacer fabric, a textile, a film, foam, a foam material, a multi-layer spacer, an insulating material, an insulator. The composite structure may comprise a set of shell segments; the set of shell segments may comprise a set of shell sections configured to be fit in radial engagement around the frame; the frame may comprise a feature configured to facilitate axial alignment of a shell section of the set of shell sections on the frame. A steering wheel assembly may comprise a rim; the rim may comprise a cover configured to provide an exterior surface and an intermediate layer under the cover; the intermediate layer may comprise at least one of a shell section and/or a soft material and/or a resilient material.

The present invention relates to a method of producing a component for a vehicle comprising the steps of providing a frame and providing a composite structure comprising a cover and a functional insert to be assembled onto the frame and assembling the composite structure with the cover and the functional insert for the frame and mechanically connecting and electrically connecting the functional insert at an interface; the interface may comprise at least one of a mechanical interface or an electrical interface for the functional insert; the interface may comprise an integrated interface comprising a mechanical interface and an electrical interface for the functional insert; mechanically connecting the functional insert is simultaneous with electrically connecting the functional insert; the interface may be configured to provide mechanical alignment of the set of shell segments and electrical connection of the functional insert segments; the interface may comprise a combined interface for mechanical alignment and electrical connection.

The present invention relates to a component for a vehicle interior comprising a steering wheel assembly comprising a frame and a composite structure configured to be assembled to the frame. The composite structure may comprise a cover and a functional insert. The composite structure may comprise an interface for each functional insert. The interface may comprise an electrical interface and a mechanical interface for the functional insert. The interface may comprise a combined interface comprising the electrical interface and the mechanical interface for the functional insert. The interface may comprise an integrated connector comprising the electrical interface and the mechanical interface for the functional insert. The electrical interface may be configured to provide an electrical connection; the electrical interface may comprise an electrical connector. The mechanical interface may be configured to provide a mechanical connection; the mechanical interface may comprise a mechanical connector. The cover may comprise a set of cover segments. Each cover segment of the set of cover segments may comprise a shell segment. The functional insert may comprise a set of functional insert segments. The composite structure may comprise a set of composite structure segments. The composite structure may comprise a set of composite structure segments comprising the set of cover segments and the set of functional insert segments. The composite structure may comprise a set of composite structure segments comprising the set of shell segments and the set of functional insert segments. The interface may be configured to provide mechanical alignment of the set of shell segments and electrical connection of the functional insert segments. The interface may comprise a combined interface for mechanical alignment and electrical connection. The electrical connection may comprise a connector. The functional insert may comprise at least one of a heating element or a sensor. The functional insert may be configured to be electrified; the functional insert may be configured to provide a functional circuit. The functional insert may comprise a set of functional insert segments configured to be mechanically connected and electrically connected at a connector provided at the interface. The functional insert may comprise a set of functional insert segments; the interface may be configured to be mechanically connected and electrically connected at a connector between functional inserts. The functional insert may comprise a set of functional insert segments configured to be mechanically connected and electrically connected at a connector comprising a wire connection provided at the interface. The functional insert may comprise a set of functional insert segments configured to be mechanically connected and electrically connected at a connector comprising a bridge connection provided at the interface. The functional insert may comprise a set of functional insert segments configured to be mechanically connected and electrically connected at a press-fit connector provided at the interface. The functional insert may comprise a set of functional insert segments configured to be mechanically connected and electrically connected at a metal-to-metal press-fit connector provided at the interface. The metal-to-metal press-fit connector may comprise a metal sheet. The functional insert may comprise a set of functional insert segments configured to be mechanically connected and electrically connected at a combined connector provided at the interface. The functional insert may comprise a set of functional insert segments configured to be mechanically connected and electrically connected at an integrated connector provided at the interface. The functional insert may comprise a set of functional insert segments configured to be mechanically connected and electrically connected at an integrated mechanical/electrical connector provided at the interface. The composite structure may comprise a set of composite structure segments; each composite structure segment may comprise a functional insert segment. The functional insert may comprise a set of functional insert segments. The functional insert may be connected to the controller at an interface. The interface may be configured to connect each functional insert segment. Each functional insert segment may be configured to be connected at a segment interface; the segment interface may comprise an integrated connector comprising a mechanical interface and an electrical interface for the functional insert segment. The interface may comprise the segment interface; the segment interface may comprise the mechanical interface and the electrical interface and a connector. The interface may comprise at least one of (a) a connector; (b) a metal connector; (c) a terminal; (d) a plug; (e) a socket for a plug; (f) a plug for a socket; (g) a plug and a socket; (h) a conductor; (j) a conductor plate; (k) a metal plate; (l) a plastic connector. The interface may comprise (a) a bridge and a base; (b) an electrical connection at the bridge and a base; and (c) a mechanical connection at the bridge and a base; (d) a mechanical connector; (e) an electrical connector; (f) a conductor. The mechanical connector may comprise an electrical interface; the electrical connector may comprise a mechanical interface. The interface may comprise a self-aligning mechanical connection. The interface may comprise a mechanical connection comprising a plastic member at a bridge and a base. The interface may comprise a self-aligning mechanical connection comprising a plastic member at a bridge and a base and/or a self-aligning mechanical connection comprising a plug and a socket. The interface may comprise a self-aligning mechanical connection comprising a plug and a socket configured to align adjacent composite structure segments. The interface may comprise at least one of (a) a press-fit electrical interface; (b) a press-fit electrical connector; (c) a plug electrical interface; (d) a plug electrical connector; (e) a plug-in electrical interface; (f) a plug-in electrical connector; (g) a plug-socket electrical interface; (h) a plug-socket electrical connector; (i) interference fit; (j) friction fit; and (k) force fit. The interface may comprise an electrical connector. The connector may comprise a bridge; the bridge may comprise a conductor. The connector may comprise a flexible element. The flexible element may comprise at least one of (a) a wire; (b) a rigid flexible wire; (c) a cable; (d) a semi-rigid wire; (e) a generally S-shaped element; (f) a generally S-shaped wire. The wire may comprise at least one of (a) a flexible insulated wire configured to fit into a connector base; (b) a semi-rigid flexible insulated wire configured to fit into a connector base; (c) a semi-rigid flexible insulated wire configured to fit at each end into a connector base; (d) a semi-rigid flexible insulated wire configured to fit at each end into a slot in a connector base; (e) a semi-rigid flexible insulated wire configured to fit at each end into a slot in a connector base to form an electrical connection for the interface; (f) an insulated wire fit into a connector comprising an insulation displacement connector (IDC). The connector may comprise a connector integrated with the functional insert. The connector may comprise a connector base. The connector may be configured to be coupled to a functional insert segment. The connector may comprise a connector base configured to be assembled to a shell segment of the composite structure. Each shell segment may comprise a base section for the connector base of the connector. The connector may comprise at least one of (a) a connector element; (b) a set of connectors; (c) a jumper; (d) an extension; (e) a plate. The connector may be configured to connect to a functional insert segment of the functional insert. The functional insert may comprise at least one of (a) a heating element; (b) a sensor; (c) a switch; (d) a functional circuit. The functional circuit may comprise a sensor; a hands-off sensor; and/or a hands-on sensor. The sensor may comprise a capacitive sensor. The functional circuit may comprise a switch; the switch may comprise a transistor; the transistor may comprise a metal-oxide-semiconductor field-effect transistor (MOSFET). The functional insert may comprise at least one of (a) a layer; (b) a mat; (c) a film; (d) a foil; (e) a molded material; (f) a single layer material; (g) a multi-layer material; (h) a fabric material; (i) a set of wires; (j) a set of wires in a molded material; (k) a set of sections. The functional insert may comprise a connector. The functional insert may comprise a set of functional insert segments. A functional insert segment may comprise a combined interface with a connector for the electrical interface and for the mechanical interface. The composite structure may comprise a set of cover segments of the cover and a set of functional insert segments of the functional insert; a functional insert segment of the functional insert may be provided within a cover segment of the cover; the interface may comprise a connector configured to retain an electrical connection between adjacent functional insert segments during misalignment of adjacent cover segments. The connector may comprise at least one of (a) a wire; (b) a bridge; (c) an S-shaped wire element; (d) a flexible S-shaped wire element; (e) a bendable S-shaped wire element; (f) a twistable S-shaped wire element. The cover may comprise a set of cover segments comprising a cover material; the cover material may comprise at least one of a resin, a plastic, a film, leather, synthetic leather, a fabric, a textile, a cork material, a sustainable leather alternative material, a molded cover material, a wrap, a wrappable material, a drapable material, a flexible cover material. The cover may be configured to fit over the functional insert. A cover segment may comprise at least one of (a) a recess for a connector for the interface; (b) a projection for a connector for the interface; (c) a surface for a connector for the interface; (d) a mount for a connector for the interface. A cover segment may comprise a seat for a connector base of a connector for the interface. The composite structure may comprise a base and/or a substrate for a functional layer of the functional insert. The composite structure may comprise a carrier; the carrier may comprise at least one of (a) a set of carrier segments; (b) a plastic material; (c) a rigid material; (d) a rigid plastic material. The base may be configured to provide alignment for the functional insert. The composite structure may comprise an intermediate layer under the functional insert. The intermediate layer may comprise a set of segments configured on a set of substrate segments of a substrate of the composite structure. The intermediate layer may comprise at least one of a spacer, a spacer fabric, a textile, a film, foam, a foam material, a multi-layer spacer, an insulating material, an insulator. The composite structure may comprise a set of shell segments; the set of shell segments may comprise a set of shell sections configured to be fit in radial engagement around the frame. The frame may comprise a feature configured to facilitate axial alignment of a shell section of the set of shell sections on the frame. The steering wheel assembly may comprise a rim; the rim may comprise a cover configured to provide an exterior surface and an intermediate layer under the cover; the intermediate layer may comprise at least one of a shell section and/or a soft material and/or a resilient material.

The present invention relates to a method of producing a component for a vehicle comprising the steps of providing a frame, providing a composite structure comprising a cover and a functional insert to be assembled onto the frame, assembling the composite structure with the cover and the functional insert for the frame, and mechanically connecting and electrically connecting the functional insert at an interface. The interface may comprise at least one of a mechanical interface or an electrical interface for the functional insert. The interface may comprise an integrated interface comprising a mechanical interface and an electrical interface for the functional insert; mechanically connecting the functional insert may be simultaneous with electrically connecting the functional insert. The interface may be configured to provide mechanical alignment of the set of shell segments and electrical connection of the functional insert segments; the interface may comprise a combined interface for mechanical alignment and electrical connection.

The present invention relates to a component for a vehicle interior comprising a base and a composite structure configured to be assembled to the base. The composite structure may comprise a cover and a functional insert. The composite structure may comprise an interface for the functional insert. The interface may comprise a mechanical interface and an electrical interface for the functional insert.

### FIGURES

FIG. 1A is a schematic perspective view of a vehicle according to an exemplary embodiment.

FIG. 1B is a schematic perspective view of a vehicle interior according to an exemplary embodiment.

FIG. 2A is a schematic perspective view of an assembly of a composite structure for a component according to an exemplary embodiment.

FIG. 2B is a schematic perspective partial cut-away view of a composite structure for a component according to an exemplary embodiment.

FIG. 2C is a schematic perspective view of an assembly of a composite structure for a component according to an exemplary embodiment.

FIG. 2D is a schematic perspective partial cut-away view of a composite structure for a component according to an exemplary embodiment.

FIGS. 3A and 3B are schematic front views of an assembly for a component according to an exemplary embodiment.

FIGS. 3C and 3D are schematic partial cross-section views of an assembly for a component according to an exemplary embodiment.

FIGS. 4A and 4B are schematic front views of an assembly for a component according to an exemplary embodiment.

FIGS. 4C and 4D are schematic partial cross-section views of an assembly for a component according to an exemplary embodiment.

FIG. 5A is a schematic front view of an assembly for a component according to an exemplary embodiment.

FIG. 5B through 5D are schematic partial cross-section views of an assembly for a component according to an exemplary embodiment.

FIGS. 6A through 6F are schematic front views of an assembly for components according to an exemplary embodiment.

FIGS. 7A through 7F are schematic front views of an assembly for components according to an exemplary embodiment.

FIGS. 8A and 8B are schematic perspective views of an assembly of a composite structure for a component according to an exemplary embodiment.

FIG. 9A is a schematic perspective view of an assembly of a composite structure for a component according to an exemplary embodiment.

FIG. 9B is a schematic exploded perspective view of an assembly for a component according to an exemplary embodiment.

FIG. 10A is a schematic perspective view of an assembly of a composite structure for a component according to an exemplary embodiment.

FIG. 10B is a schematic exploded perspective view of an assembly for a component according to an exemplary embodiment.

FIG. 11A is a schematic perspective view of an assembly of a composite structure for a component according to an exemplary embodiment.

FIGS. 11B through 11E are schematic perspective exploded views of an assembly with a composite structure for a component according to an exemplary embodiment.

FIG. 12A is a schematic perspective view of an assembly with a composite structure for a component according to an exemplary embodiment.

FIG. 12B is a schematic perspective exploded view of an assembly with a composite structure for a component according to an exemplary embodiment.

FIG. 13A is a schematic perspective view of an assembly with a composite structure for a component according to an exemplary embodiment.

FIG. 13B is a schematic perspective view of an assembly with a composite structure for a component according to an exemplary embodiment.

FIG. 13C is a schematic section perspective view of a composite structure for a component according to an exemplary embodiment.

FIG. 13D is a schematic perspective view of an assembly with a composite structure for a component according to an exemplary embodiment.

FIG. 13E is a schematic section perspective view of a composite structure for a component according to an exemplary embodiment.

FIG. 14A is a schematic front view of an assembly with a composite structure for a component according to an exemplary embodiment.

FIG. 14B is a schematic exploded perspective view of an assembly with a composite structure for a component according to an exemplary embodiment.

FIG. 14C is a schematic perspective partial cut-away view of an assembly with a composite structure for a component according to an exemplary embodiment.

FIG. 15A is a schematic exploded perspective view of an assembly with a composite structure for a component according to an exemplary embodiment.

FIGS. 15B through 15D are schematic cross-section views of an assembly of a composite structure for a component according to an exemplary embodiment.

FIG. 16A is a schematic exploded perspective view of an assembly with a composite structure for a component according to an exemplary embodiment.

FIGS. 16B through 16D are schematic cross-section views of an assembly of a composite structure for a component according to an exemplary embodiment.

FIG. 17A is a schematic exploded perspective view of an assembly with a composite structure for a component according to an exemplary embodiment.

FIGS. 17B though 17D are schematic cross-section views of an assembly of a composite structure for a component according to an exemplary embodiment.

FIG. 18A is a schematic exploded perspective view of an assembly with a composite structure for a component according to an exemplary embodiment.

FIGS. 18B through 18D are schematic cross-section views of an assembly of a composite structure for a component according to an exemplary embodiment.

FIGS. 19A and 19B are schematic partial top views of an assembly for a component according to an exemplary embodiment.

FIGS. 20A through 20D are schematic perspective partial views of an assembly with a composite structure for a component according to an exemplary embodiment.

FIGS. 21A through 21D are schematic perspective partial views of an assembly with a composite structure for a component according to an exemplary embodiment.

FIGS. 22A through 22D are schematic perspective views of a connector for a component according to an exemplary embodiment.

FIGS. 23A and 23B are schematic perspective partial views of an assembly with a composite structure for a component according to an exemplary embodiment.

FIGS. 23C and 23D are schematic perspective views of a connector for a component according to an exemplary embodiment.

FIGS. 23E and 23F are schematic exploded perspective partial views of an assembly with a composite structure for a component according to an exemplary embodiment.

FIG. 23G is a schematic perspective partial view of an assembly with a composite structure for a component according to an exemplary embodiment.

FIGS. 24A and 24B are schematic perspective views of a connector for a component according to an exemplary embodiment.

FIGS. 24C through 24E are schematic perspective partial views of an assembly with a composite structure for a component according to an exemplary embodiment.

FIGS. 25A and 25B are schematic perspective partial views of an assembly with a composite structure for a component according to an exemplary embodiment.

FIGS. 25C and 25D are schematic perspective views of a connector for a component according to an exemplary embodiment.

FIGS. 25E and 25F are schematic perspective partial views of an assembly with a composite structure for a component according to an exemplary embodiment.

FIG. 26A is a schematic perspective view of a connector for a component according to an exemplary embodiment.

FIGS. 26B and 26C are schematic perspective partial views of an assembly with a composite structure for a component according to an exemplary embodiment.

FIGS. 27A and 27B are schematic perspective partial views of an assembly with a composite structure for a component according to an exemplary embodiment.

FIG. 27C is a schematic perspective view of a connector for a component according to an exemplary embodiment.

FIGS. 27D through 27F are schematic perspective partial views of an assembly with a composite structure for a component according to an exemplary embodiment.

FIGS. 28, 28A and 28B are schematic diagrams of a connector for a component according to an exemplary embodiment.

FIGS. 29A and 29B are schematic perspective views of a connector for a component according to an exemplary embodiment.

FIGS. 29C through 29E are schematic perspective partial views of an assembly with a composite structure for a component according to an exemplary embodiment.

FIGS. 30A and 30B are schematic perspective partial cross-section views of a composite structure for a component according to an exemplary embodiment.

FIGS. 31A and 31B are schematic diagrams of a functional system for a component according to an exemplary embodiment.

FIGS. 32A through 32D are schematic diagrams of a functional system for a component according to an exemplary embodiment.

FIGS. 33A through 33C are schematic diagrams of a functional system for a component according to an exemplary embodiment.

FIG. 34A is a schematic perspective exploded view of an assembly with a composite structure for a component according to an exemplary embodiment.

FIGS. 34B and 34C are schematic perspective partial exploded views of an assembly with a composite structure for a component according to an exemplary embodiment.

FIGS. 34D through 34G are schematic partial cross-section view of an assembly for a component according to an exemplary embodiment.

FIG. 35A is a schematic perspective view of an assembly for a component according to an exemplary embodiment.

FIGS. 35B and 35C are schematic perspective exploded views of an assembly for a component according to an exemplary embodiment.

FIGS. 35D and 35E are schematic perspective views of an assembly for a component according to an exemplary embodiment.

FIGS. 36A through 36D are schematic perspective exploded views of an assembly for a component according to an exemplary embodiment.

FIGS. 37A through 37C are schematic perspective partial exploded views of an assembly with a composite structure for a component according to an exemplary embodiment.

FIG. 38A is a schematic perspective partial view of an assembly with a composite structure for a component according to an exemplary embodiment.

FIG. 38B is a schematic diagram of a functional system for a component according to an exemplary embodiment.

FIG. 38C is a schematic cross-section view of an assembly of a composite structure for a component according to an exemplary embodiment.

FIG. 38D is a schematic diagram of a functional system for a component according to an exemplary embodiment.

FIG. 38E is a schematic cross-section view of an assembly of a composite structure for a component according to an exemplary embodiment.

FIG. 38F is a schematic cross-section view of an assembly of a composite structure for a component according to an exemplary embodiment.

FIG. 39A is a schematic perspective partial view of an assembly with a composite structure for a component according to an exemplary embodiment.

FIG. 39B is a schematic diagram of a functional system for a component according to an exemplary embodiment.

FIG. 39C is a schematic cross-section view of an assembly of a composite structure for a component according to an exemplary embodiment.

FIG. 39D is a schematic cross-section view of an assembly of a composite structure for a component according to an exemplary embodiment.

FIG. 39E is a schematic diagram of a functional system for a component according to an exemplary embodiment.

FIG. 39F is a schematic cross-section view of an assembly of a composite structure for a component according to an exemplary embodiment.

FIG. 39G is a schematic cross-section view of an assembly of a composite structure for a component according to an exemplary embodiment.

FIG. 40A is a schematic perspective partial view of an assembly with a composite structure for a component according to an exemplary embodiment.

FIG. 40B is a schematic diagram of a functional system for a component according to an exemplary embodiment.

FIG. 40C is a schematic cross-section view of an assembly of a composite structure for a component according to an exemplary embodiment.

FIG. 40D is a schematic cross-section view of an assembly of a composite structure for a component according to an exemplary embodiment.

FIG. 40E is a schematic diagram of a functional system for a component according to an exemplary embodiment.

FIG. 40F is a schematic cross-section view of an assembly of a composite structure for a component according to an exemplary embodiment.

FIG. 40G is a schematic cross-section view of an assembly of a composite structure for a component according to an exemplary embodiment.

FIGS. 41A through 41F are schematic cross-section views of an assembly of a composite structure for a component according to an exemplary embodiment.

FIGS. 42A through 42F are schematic cross-section views of an assembly of a composite structure for a component according to an exemplary embodiment.

FIG. 43A is a schematic flow diagram of a process to manufacture a component according to an exemplary embodiment.

FIG. 43B is a schematic flow diagram of a process to manufacture a component according to an exemplary embodiment.

FIG. 43C is a schematic flow diagram of a process to manufacture a component according to an exemplary embodiment.

FIG. 43D is a schematic flow diagram of a process to manufacture a component according to an exemplary embodiment.

FIG. 43E is a schematic flow diagram of a process to manufacture a component according to an exemplary embodiment.

FIG. 44A is a schematic flow diagram of a process to manufacture a steering wheel assembly according to an exemplary embodiment.

FIG. 44B is a schematic flow diagram of a process to manufacture a steering wheel assembly according to an exemplary embodiment.

FIG. 45 is a schematic diagram of a functional system for a component according to an exemplary embodiment.

FIG. 46 is a schematic diagram of a functional system for a component according to an exemplary embodiment.

FIGS. 47A and 47B are schematic diagrams of a functional system for a component according to an exemplary embodiment.

FIGS. 48A and 48B are schematic perspective views of a vehicle interior according to an exemplary embodiment.

FIG. 49A is a schematic perspective partial view of an assembly with a composite structure for a component according to an exemplary embodiment.

FIG. 49B is a schematic perspective partial detail view of an assembly with a composite structure for a component according to an exemplary embodiment.

FIG. 49C is a schematic perspective partial view of an assembly with a composite structure for a component according to an exemplary embodiment.

### DESCRIPTION

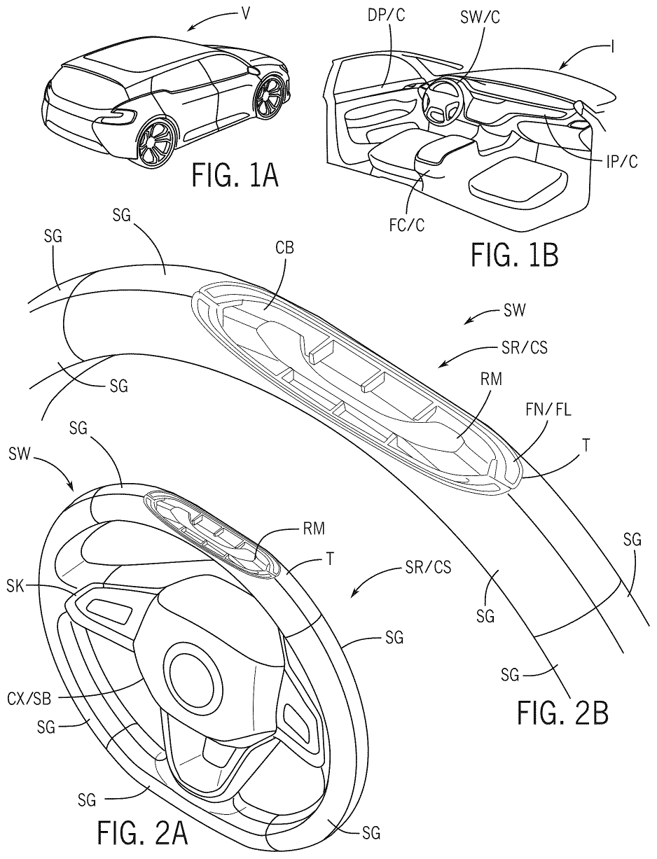

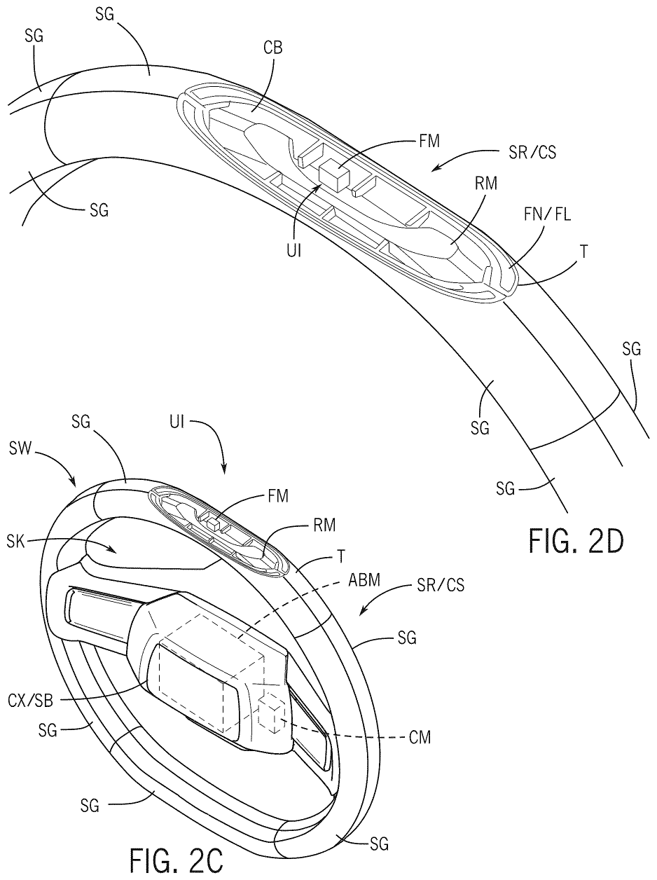

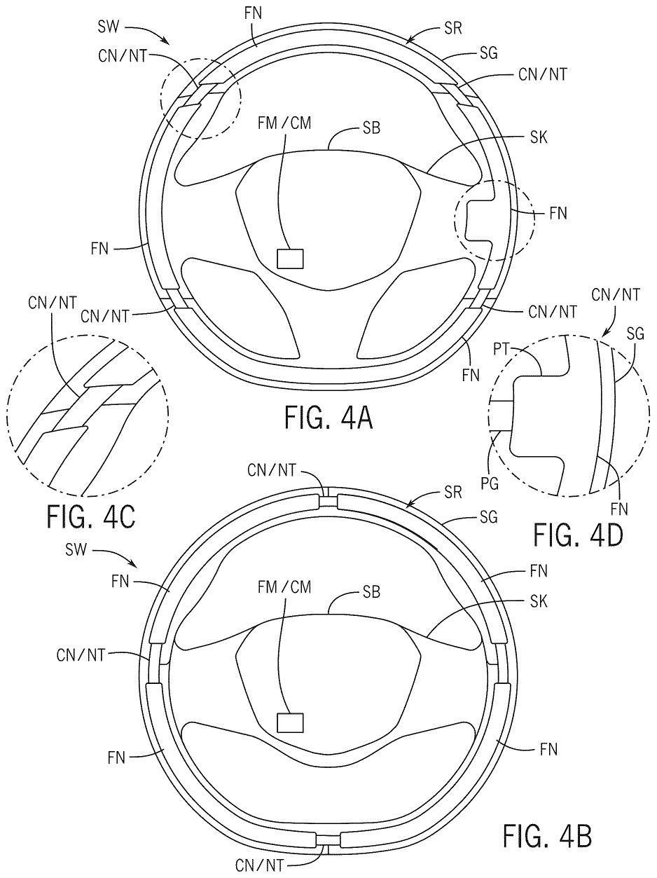

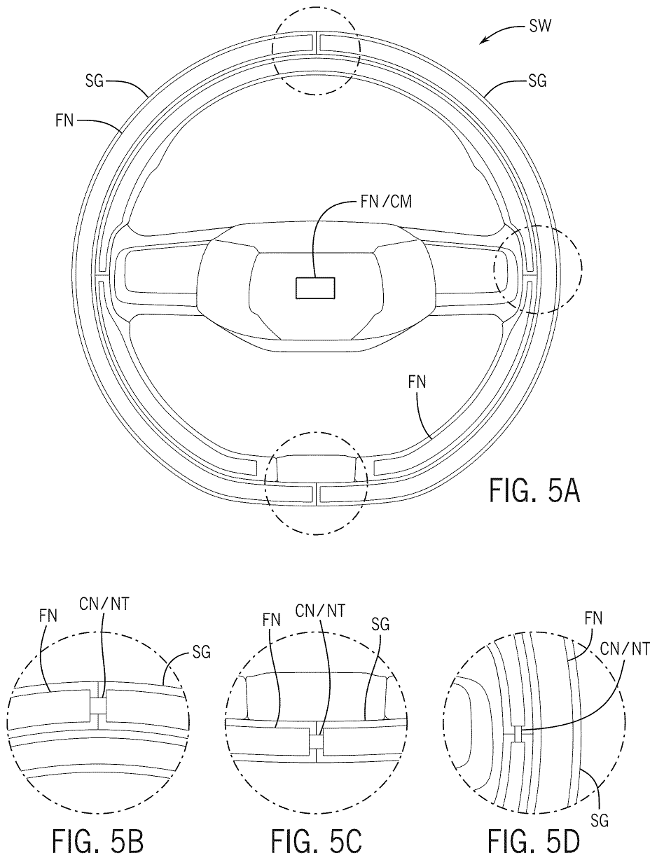

Referring to FIGS. 1A-1B, a vehicle V is shown with an interior I comprising components C including trim panels such as instrument panel IP and a door panel DP and a console shown as floor console FC and a steering wheel assembly SW. See also FIGS. 2A-2D, 3A-3D, 4A-4D, 5A-5D, 8A-8B, 48A-48B and 49A-49C.

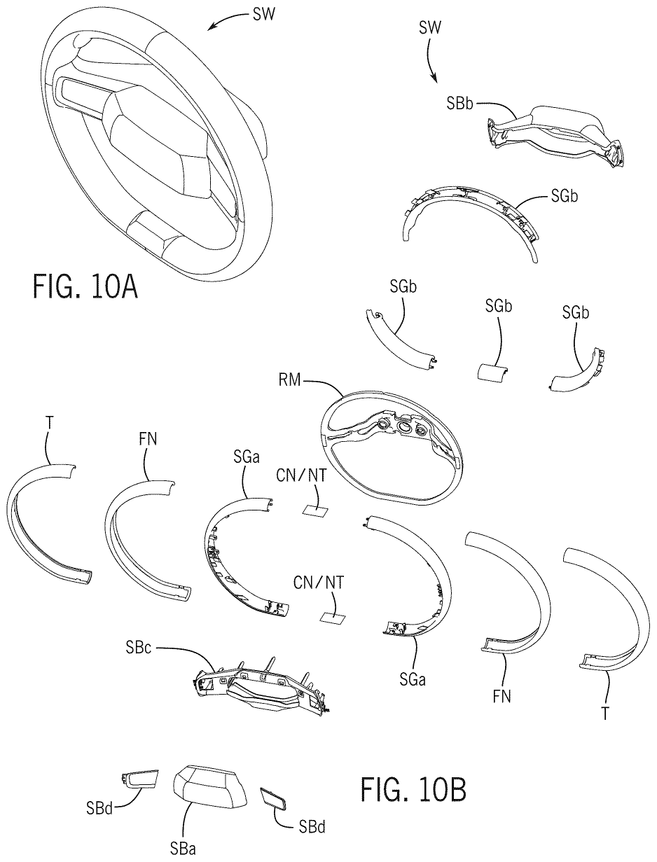

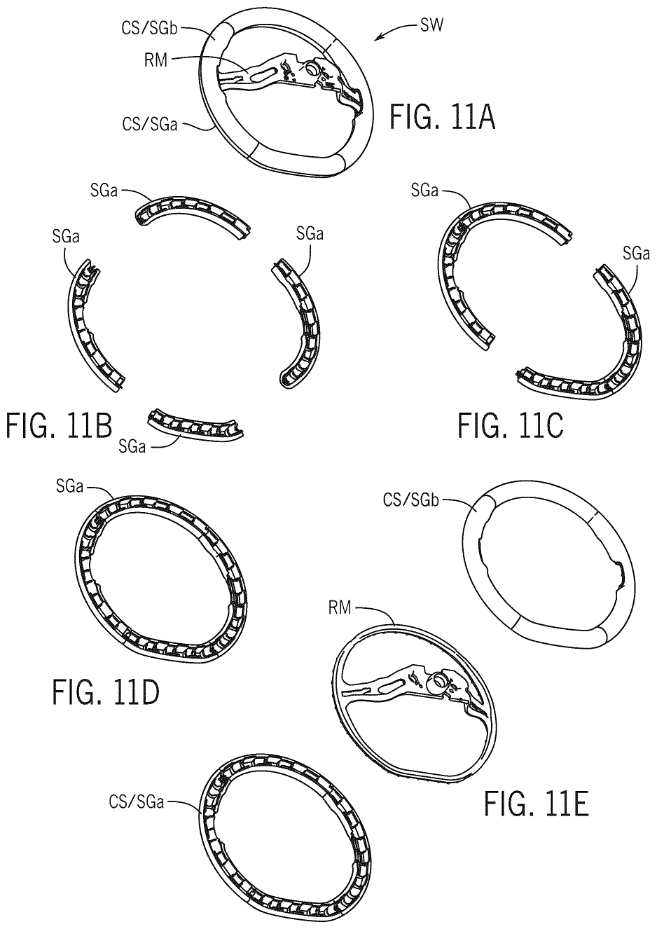

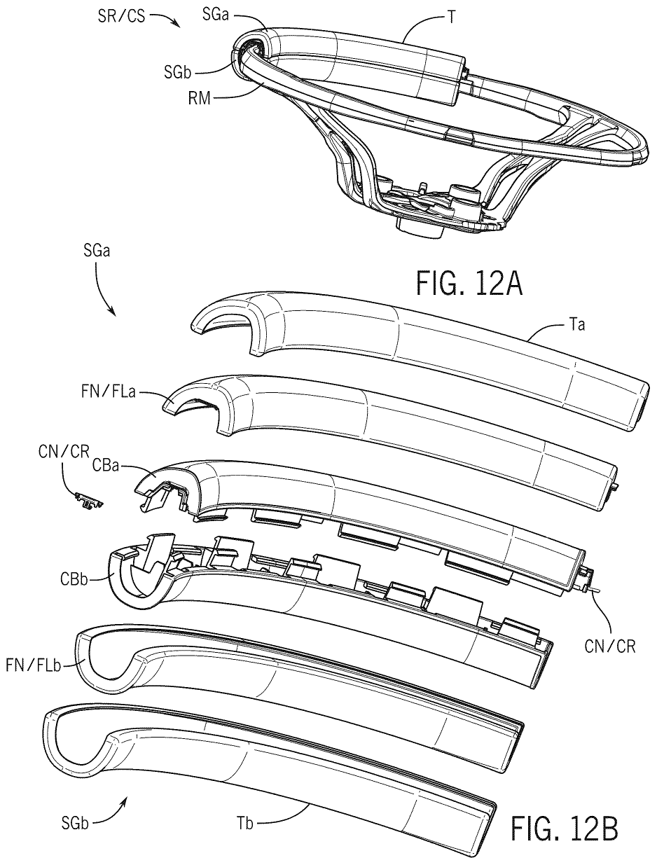

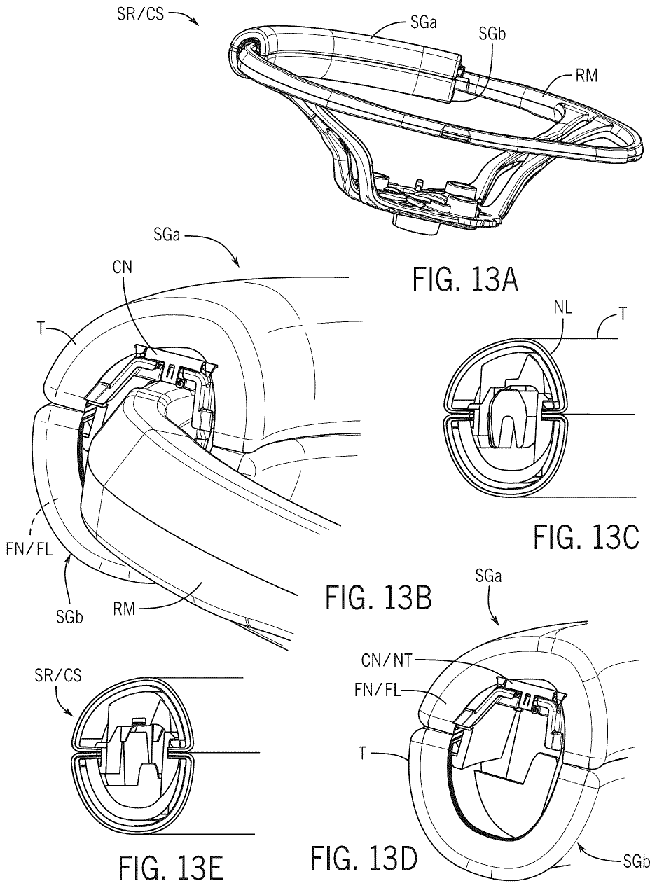

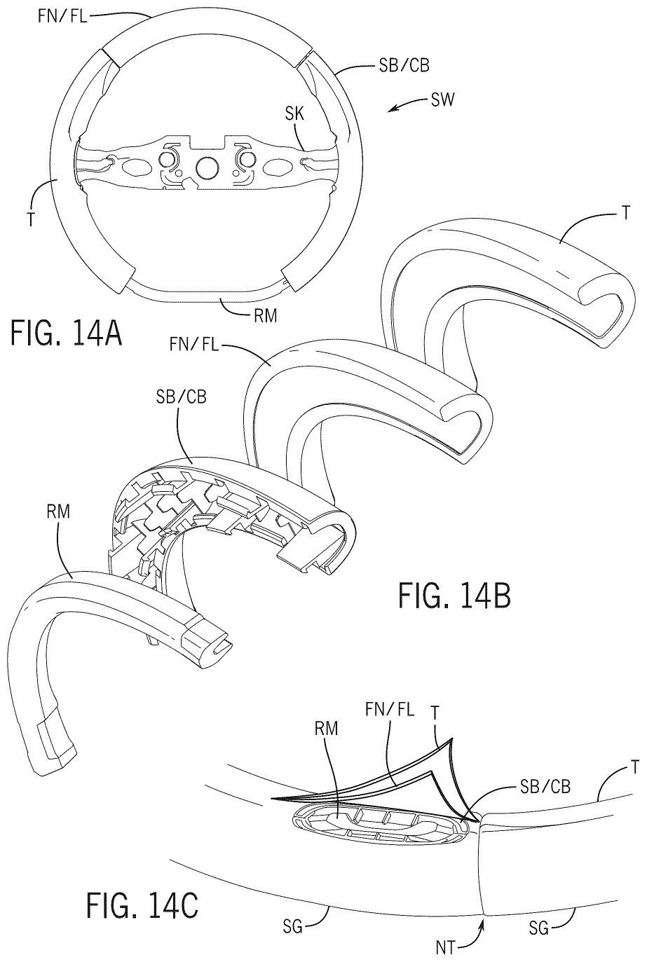

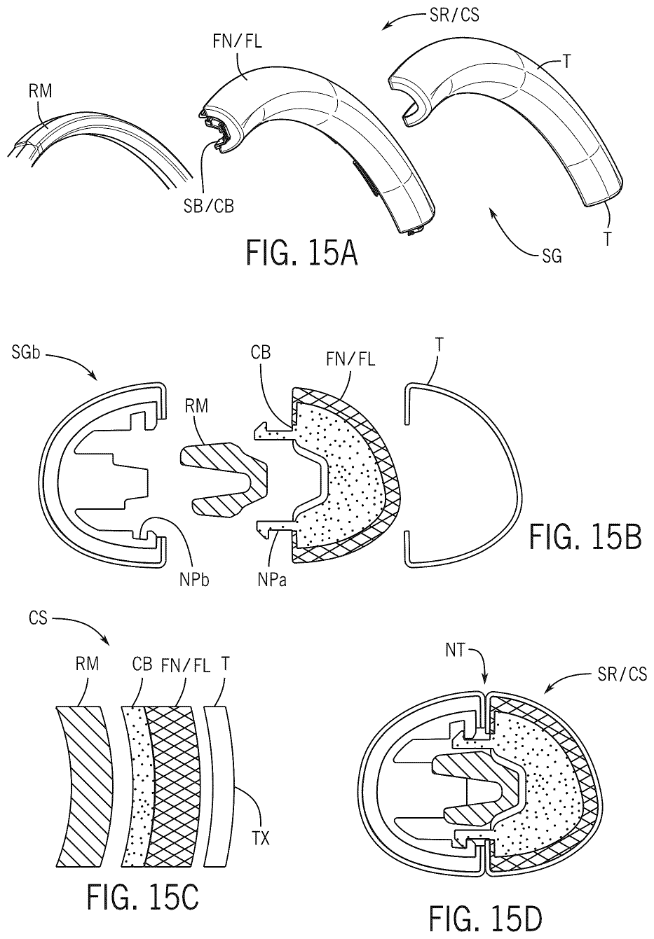

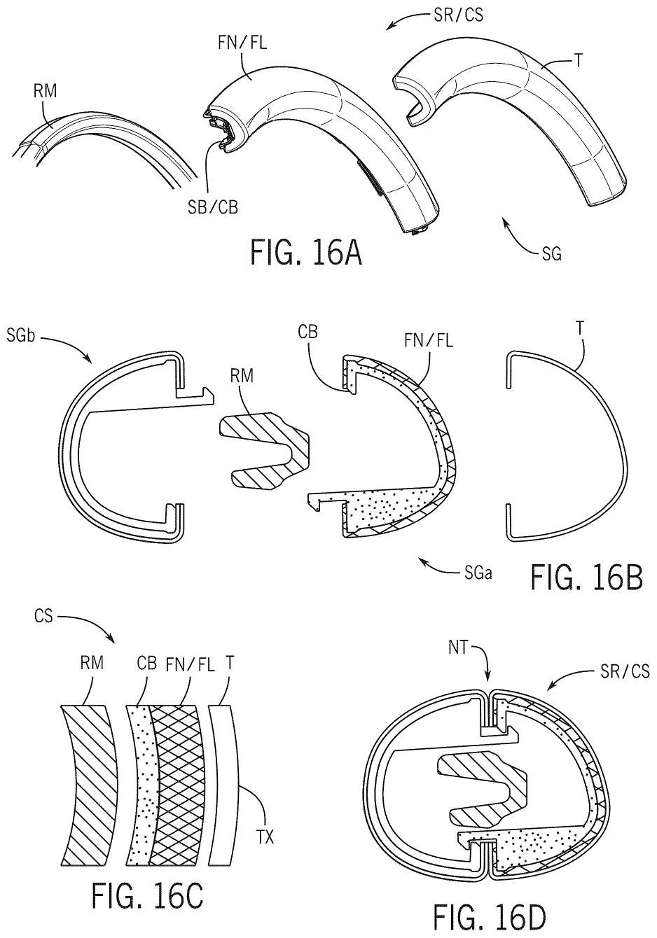

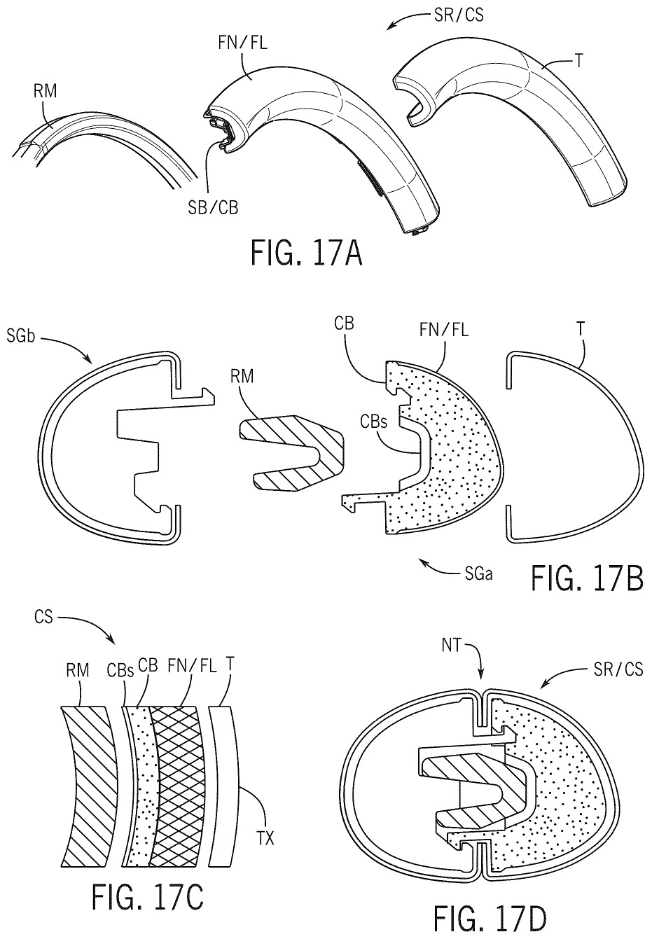

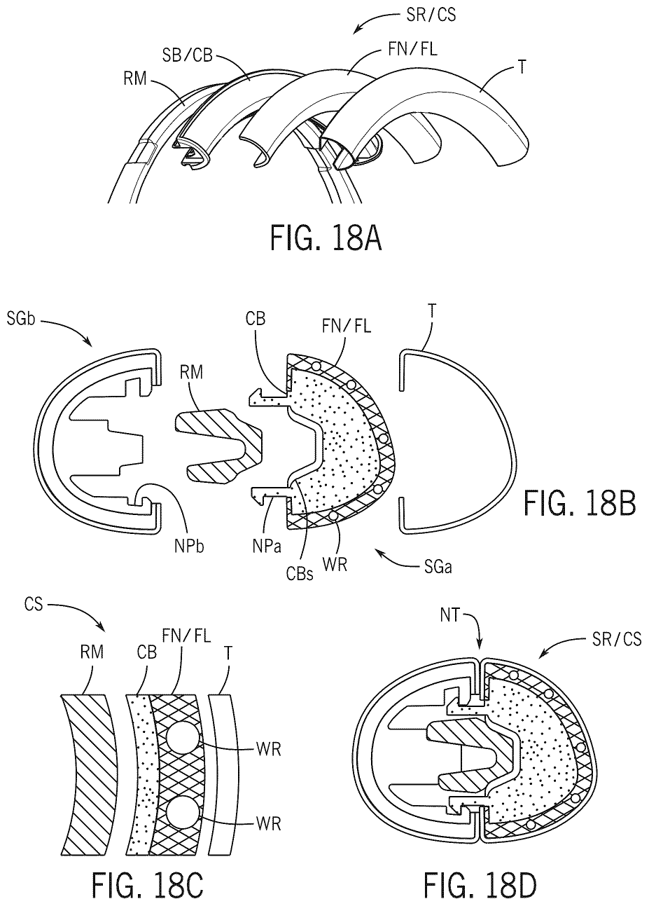

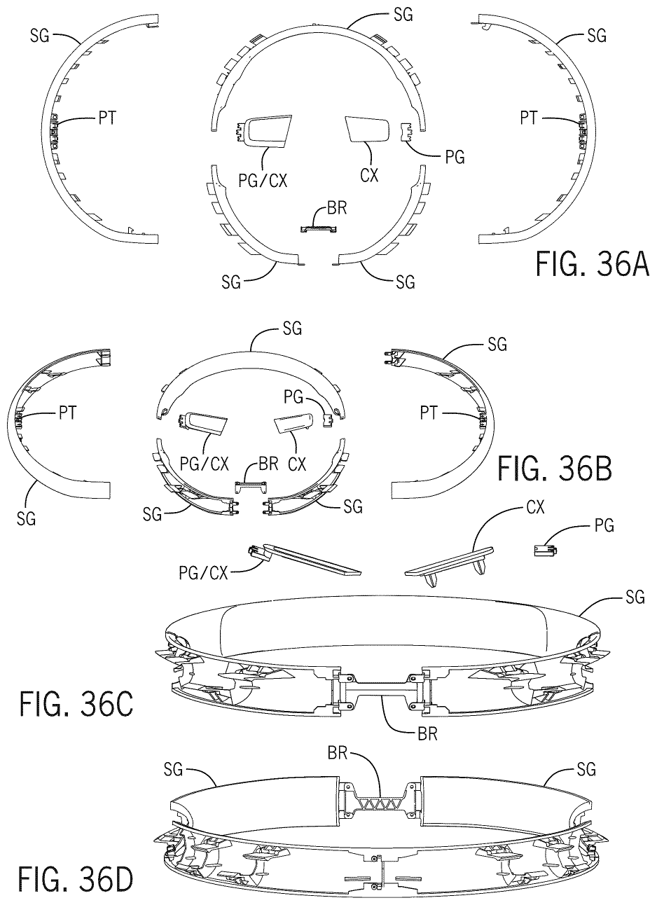

According to an exemplary embodiment as shown schematically in FIGS. 2A-2D, 8A-8B, 9A-9B, 10A-10B, 11A-11E, 12A-12B, 13A-13E, 14A-14C, 15A-15D, 16A-16D, 17A-17D and 18A-18D, the component shown as steering wheel/assembly SW may comprise a center/base section CX/SB (with an emblem/logo) and a spoke structure SK with a rim SR; rim SR may comprise a composite structure CS assembled on a frame RM; rim SR with composite structure CS may comprise a set of segments SG; segments SG may comprise a cover T providing an exterior/cover layer TX (such as a decorative layer DL) and a functional insert FN comprising a functional layer FL on a base/carrier CB. See also FIGS. 14A-14C and 36A-36D.

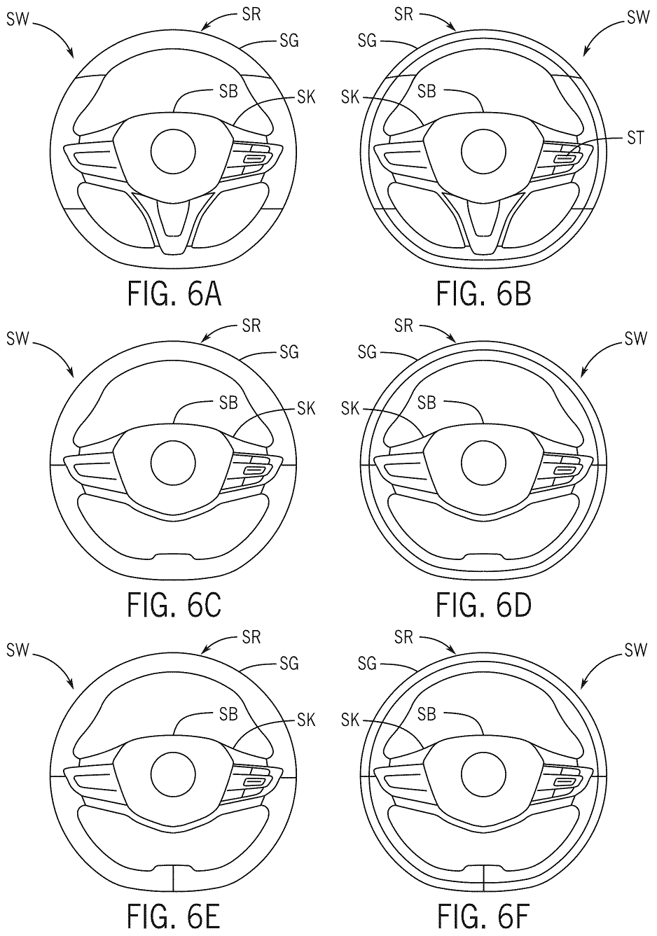

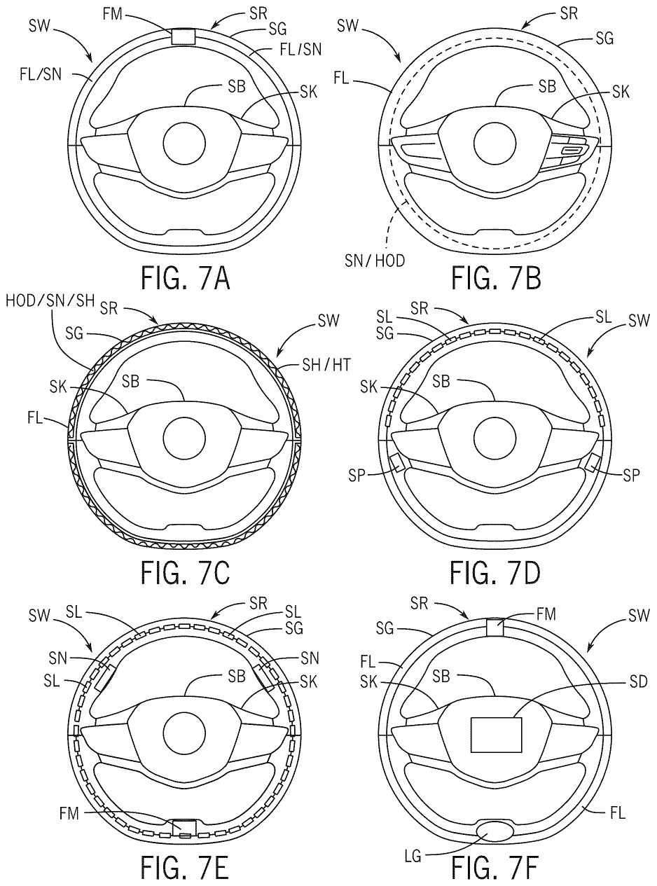

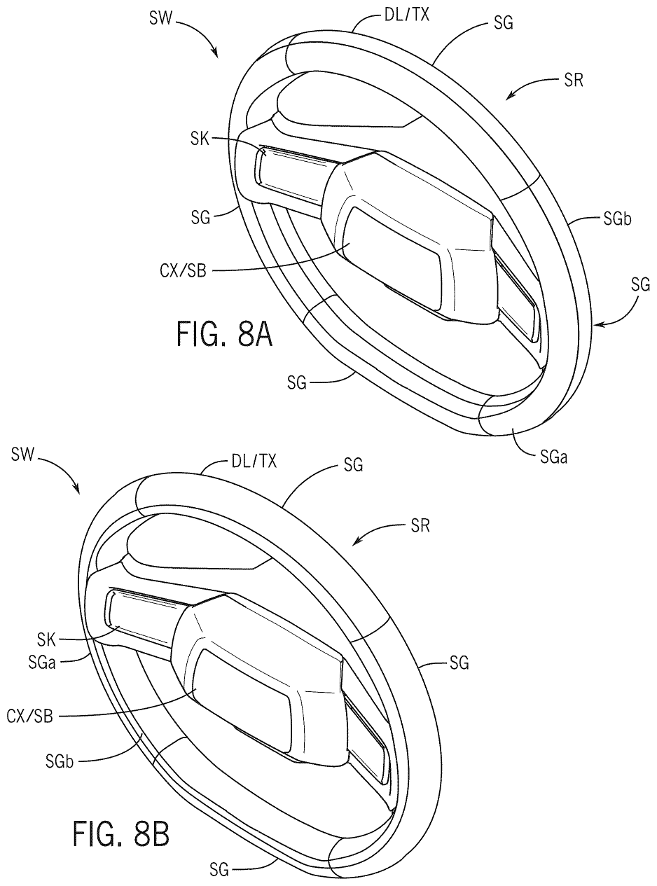

As indicated schematically in FIGS. 6A-6F and 7A-7F, steering wheel SW may be provided in any of a wide variety of configurations of base SB and/or spokes SK and/or rim SR with segments SG; as indicated schematically, rim SR may comprise any of a wide variety of configurations of segments SG; segments SG may be provided in any of a wide variety of configurations; rim SR may comprise segments SG in an axially-arranged orientation (e.g. adjacent segments/sections); rim SR may comprise segments with sections in a radial arrangement (e.g. segment shell sections SGa and SGb configured to be assembled onto the frame of the rim SR). See also FIGS. 2A-2D, 3A-3D, 4A-4D, 5A-5D, 8A-8B, 9A-9B, 10A-10B, 11A-11E, 12A-12B, 13A-13E, 14A-14C, 15A-15D, 16A-16D, 17A-17D, 18A-18D and 36A-36D.

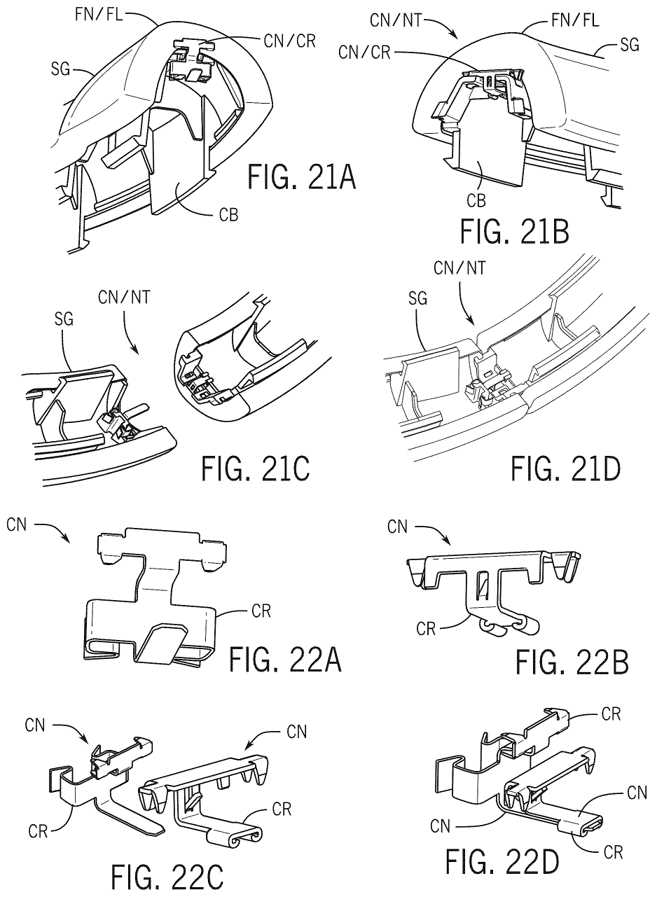

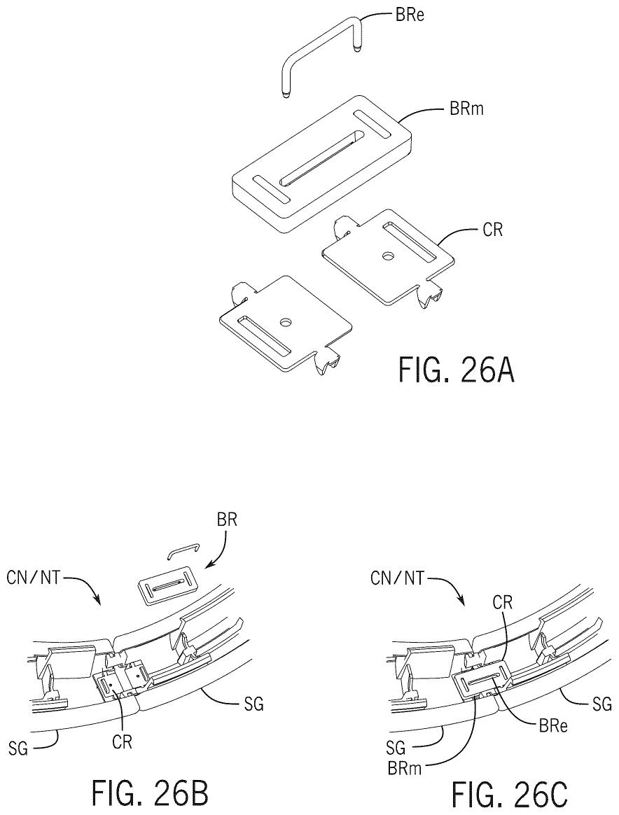

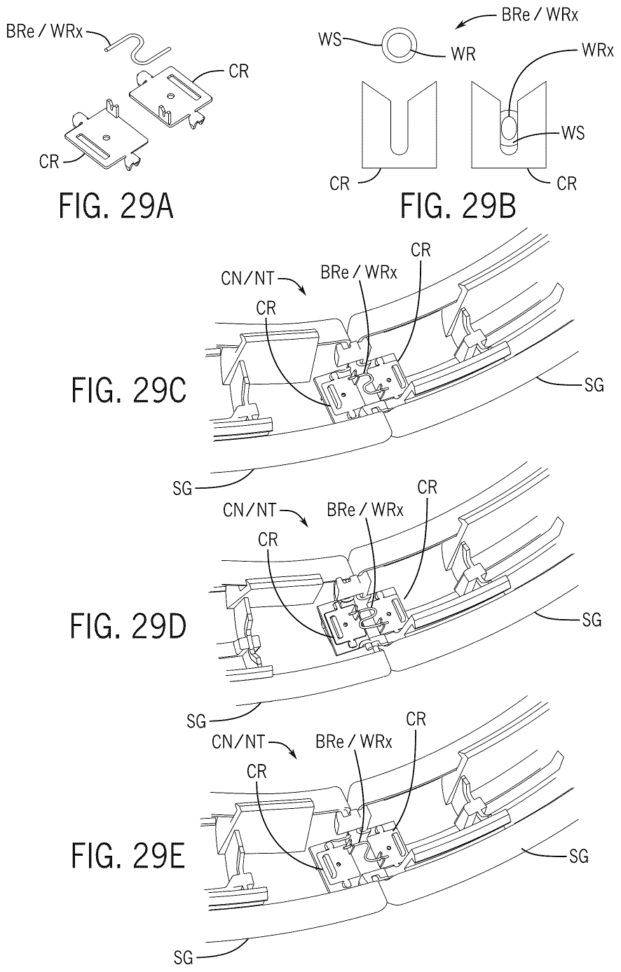

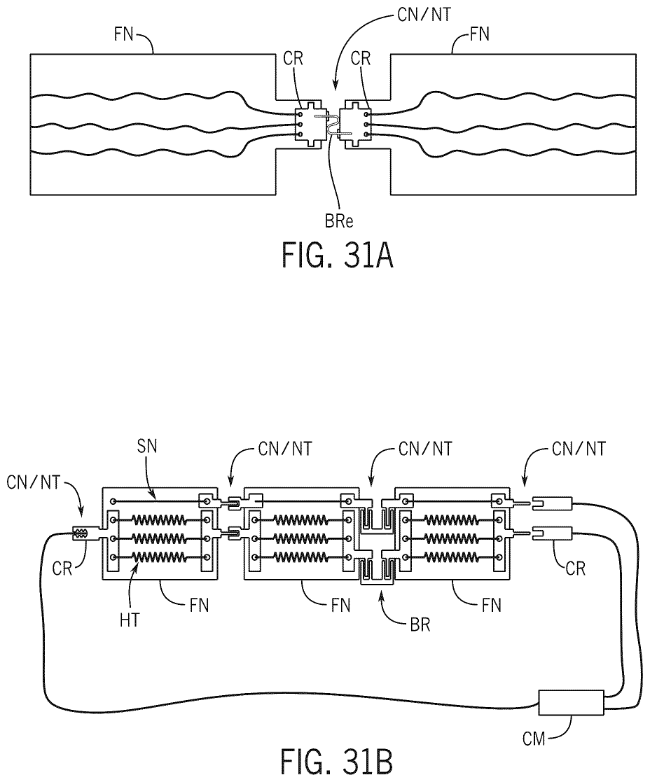

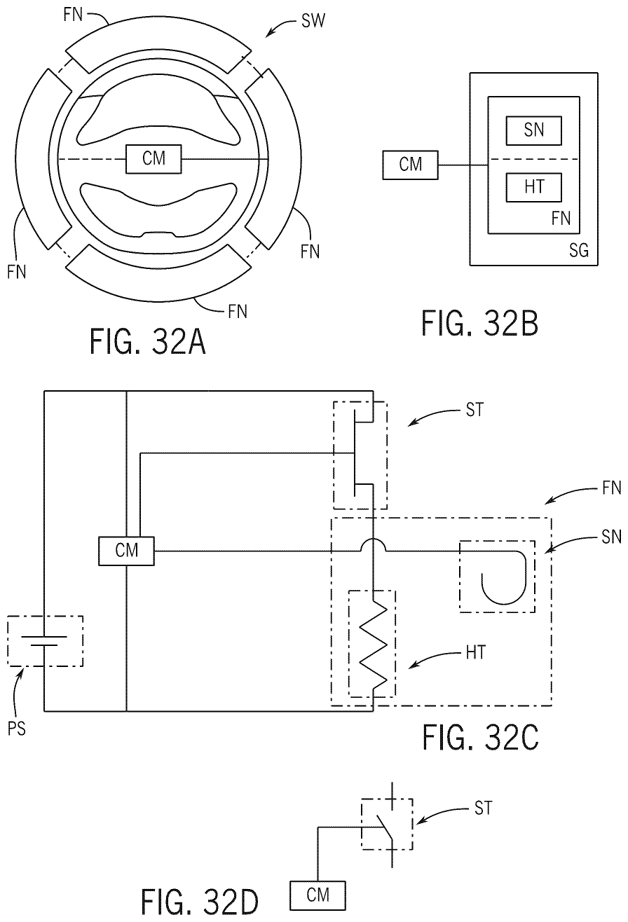

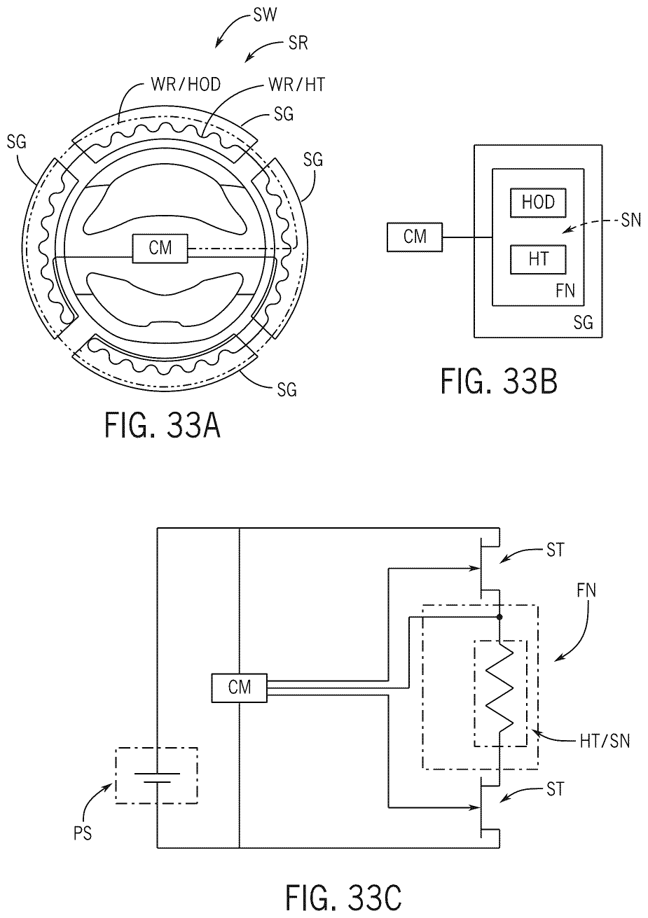

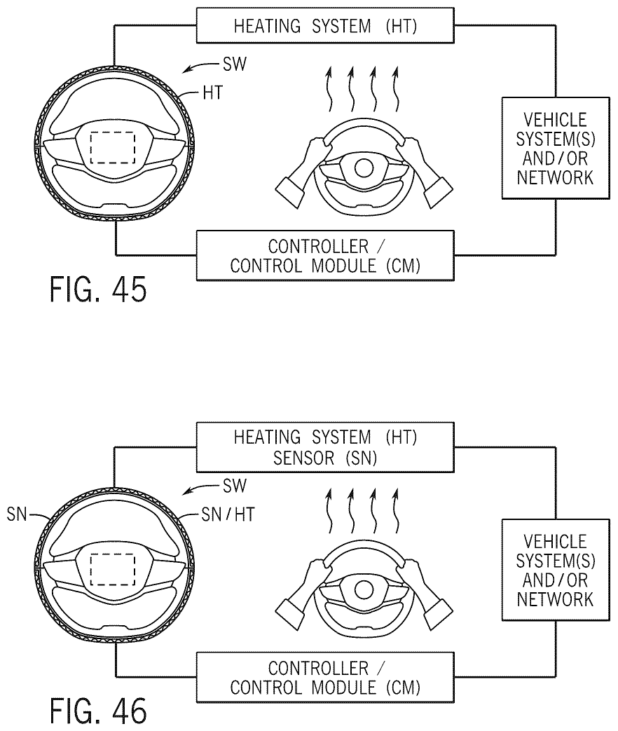

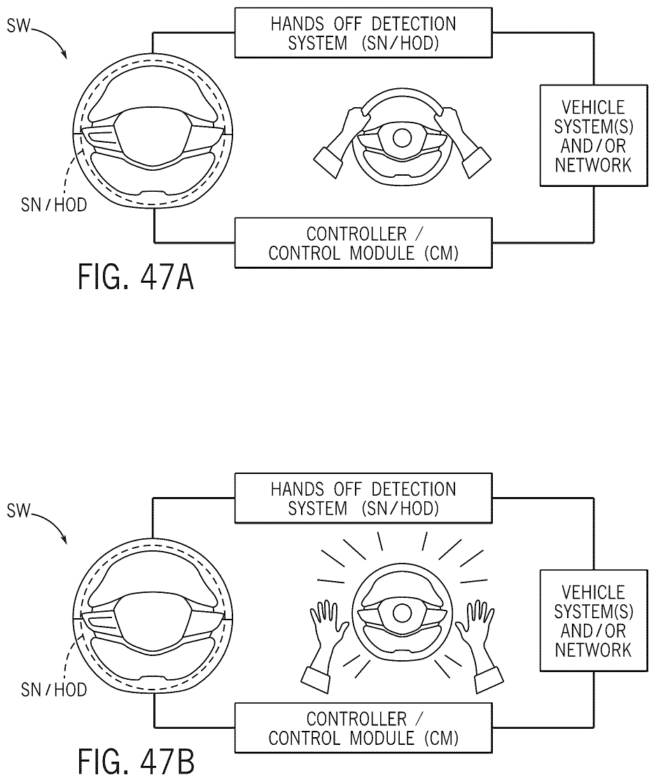

According to an exemplary embodiment as shown schematically in FIGS. 2A-2D, 3A-3D, 4A-4D and 5A-5D, steering wheel SW may comprise a rim SR with composite structure CS with segments SG that may be configured to provide a functional insert FN; functional insert FN may comprise a set of functional insert segments configured to be connected at an interface NT by a connector BR and/or CR; functional insert FN may be configured to provide a functional system/circuit with wires/wiring WR for functional/circuit elements such as a sensor/element SN (e.g. for hands-off/on detection HOD) and/or a heating section or element HT and or a switch ST with a power supply/source PS. See also FIGS. 31A-31B, 32A-32D, 33A-33C, 45, 46 and 47A-47B. As indicated schematically in FIGS. 2A-2D, 31A-31B, 2A-32D, 33A-33C, 45, 46 and 47A-47B, steering wheel SW with functional insert FN may be configured to provide functional circuit elements such as sensor SN/HOD and heating element HT and/or a user interface UI (e.g. configured to provide input/output signals and/or functionality such as sensor/detector elements and/or interconnectivity to vehicle systems and other systems through a functional module FM and/or a control module CM; center section CX may comprise control module CM and/or an airbag module ABM. See FIGS. 2A-2D, 3A-3B, 4A-4B and 5A-5B.

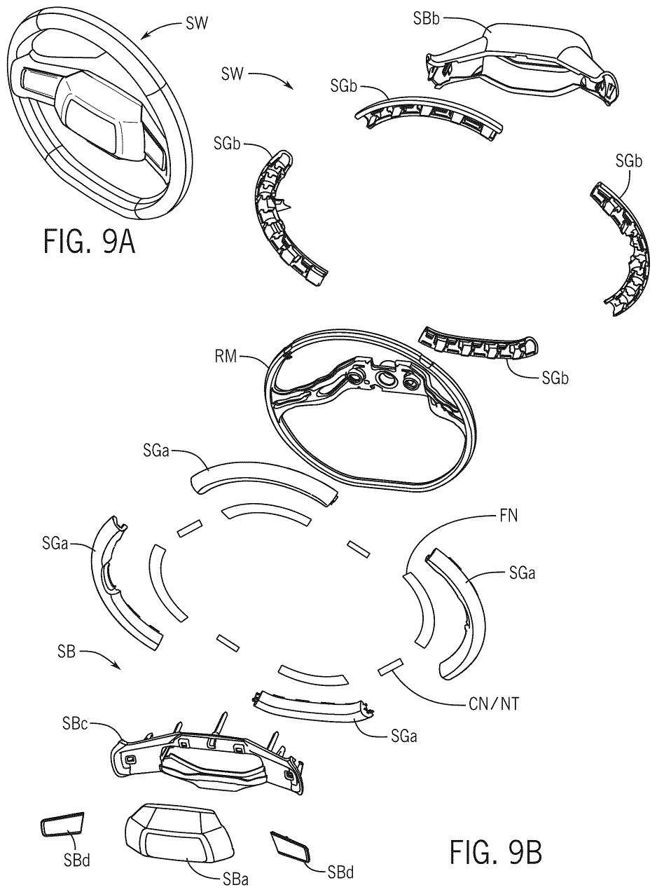

According to an exemplary embodiment as shown schematically in FIGS. 2A-2D, 3A-3B, 4A-4B, 5A-5D and 14A-14C, the component comprising steering wheel assembly SW may comprise a frame RM and a composite structure CS configured to be assembled as a rim SR on the frame; composite structure CS may comprise a cover T and a functional insert FN and an interface NT configured to provide a connector CT for each segment of functional insert FN; steering wheel/assembly SW may comprise a composite structure CS for rim SR comprising shell/structure segments SG and the segments of functional insert FN; interface NT may comprise an electrical interface and a mechanical interface; the interface may comprise a combined/integrated interface/connector CN/NT comprising the electrical interface/connector and the mechanical interface/connector. See also FIGS. 9A-9B, 10A-10B, 11A-11E, 12A-12B, 13A-13E, 19A-19B, 20A-20D, 21A-21D, 22A-22D, 23A-23G, 24A-24E, 25A-25F, 26A-26C. 27A-27F, 28, 28A-28B, 29A-29E and 30A-30B.

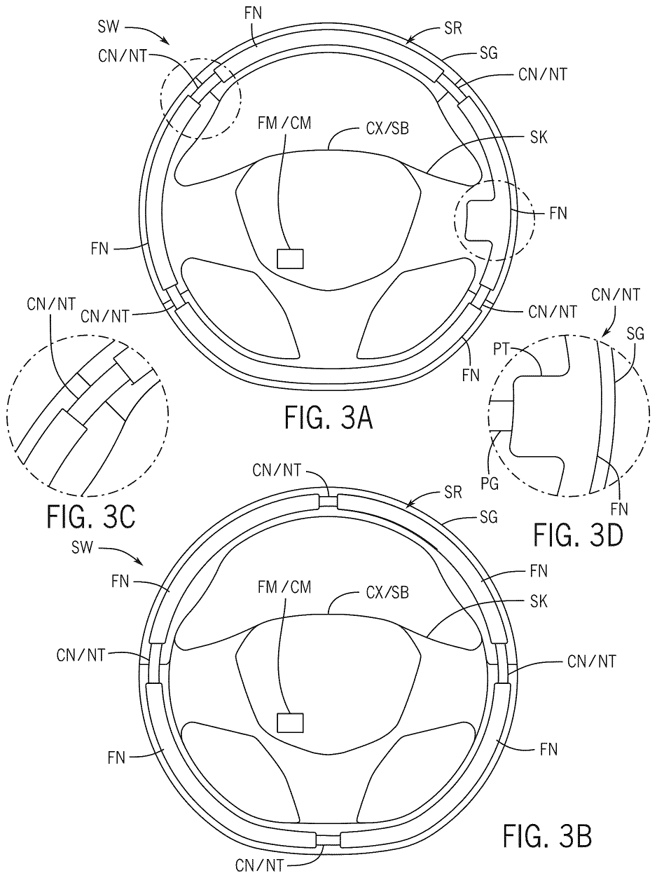

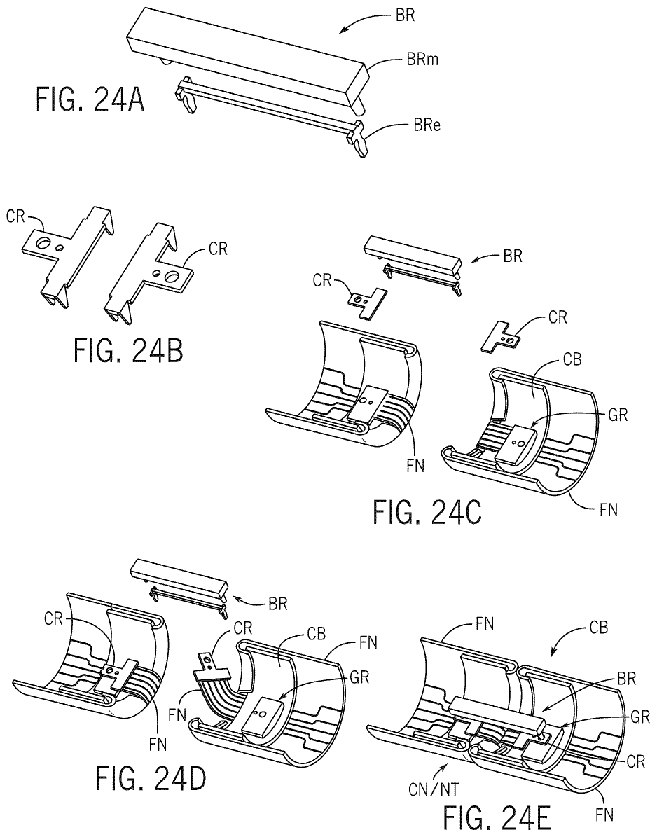

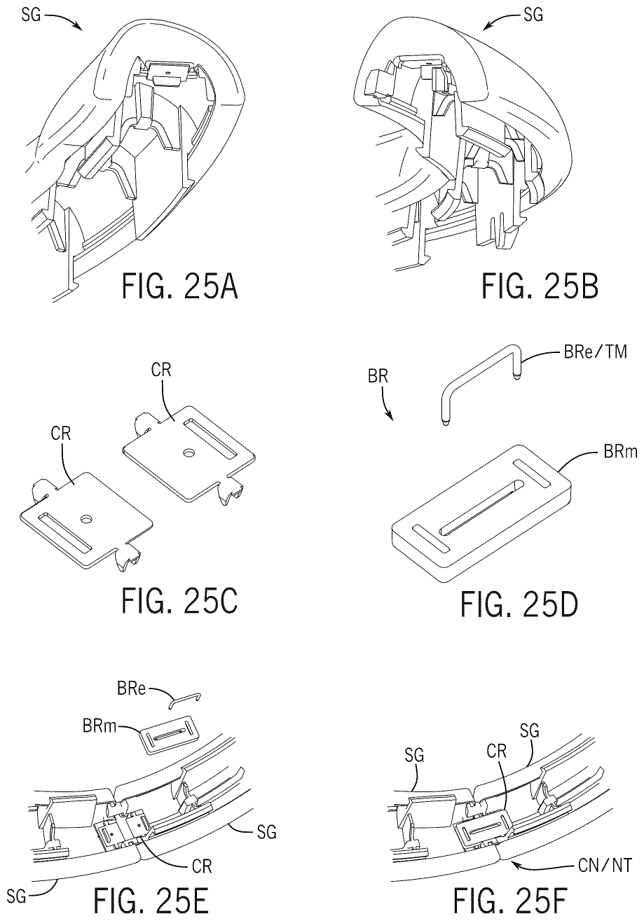

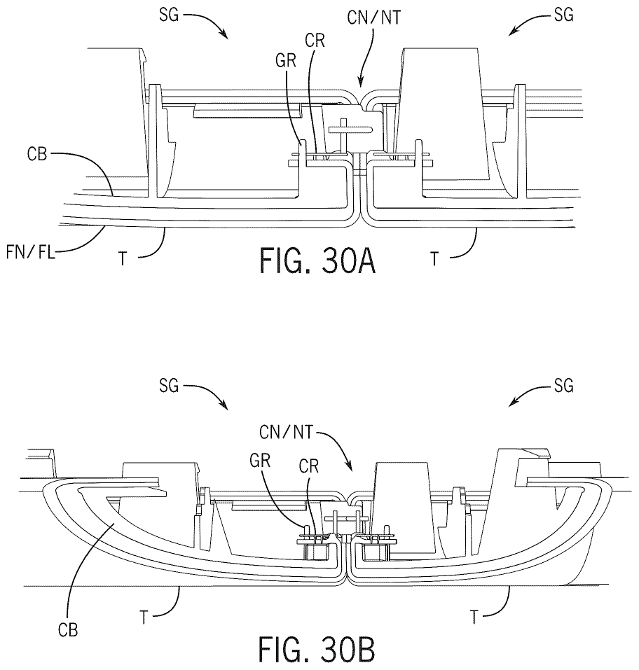

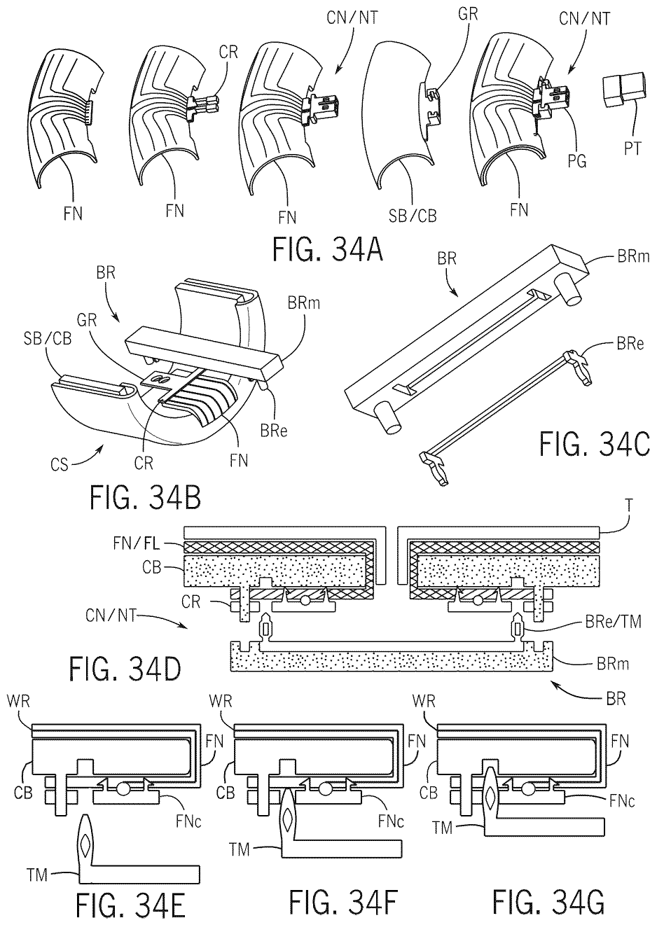

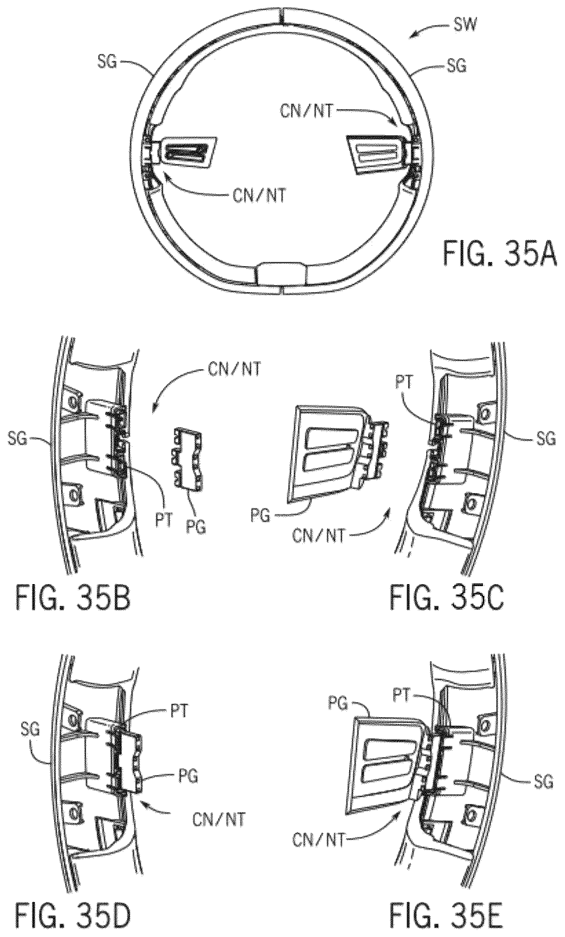

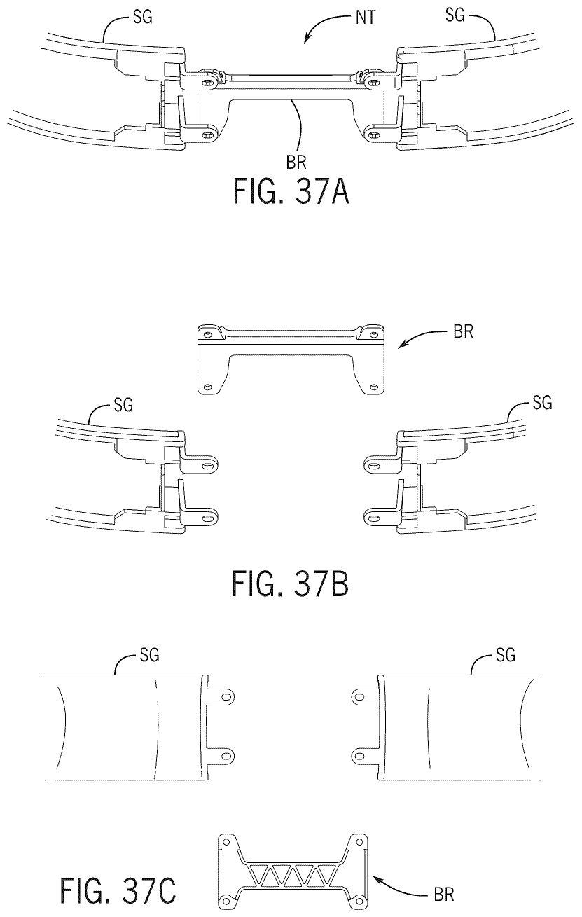

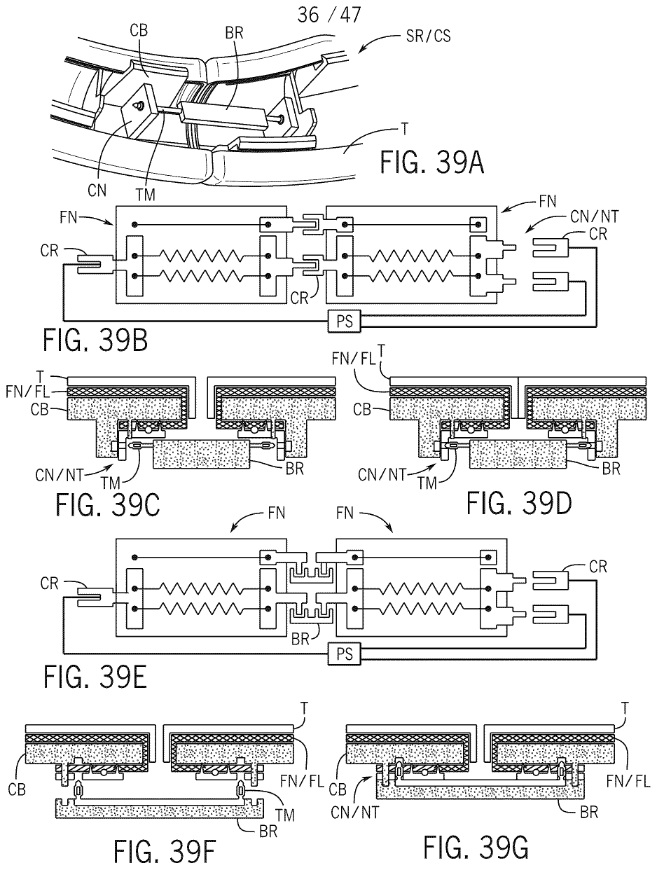

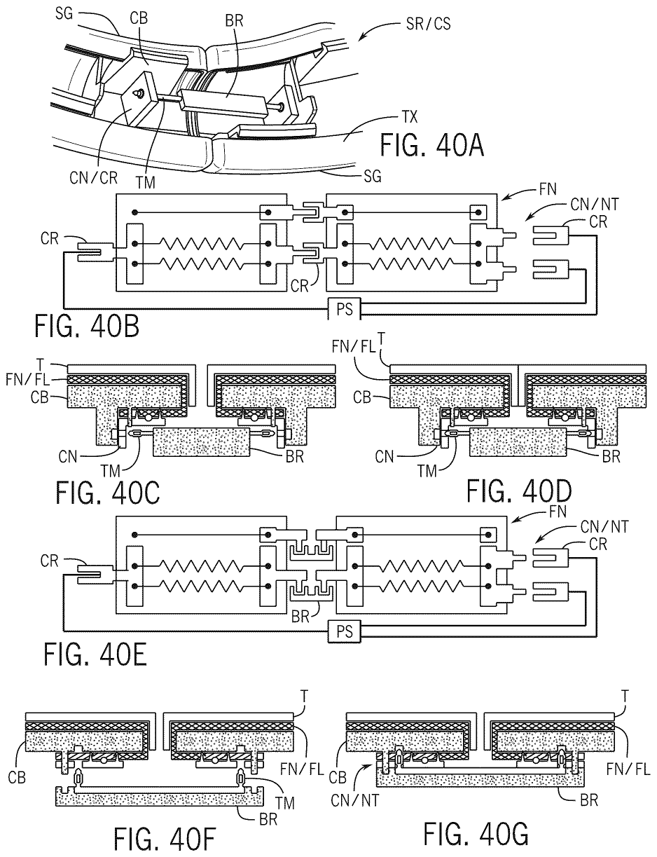

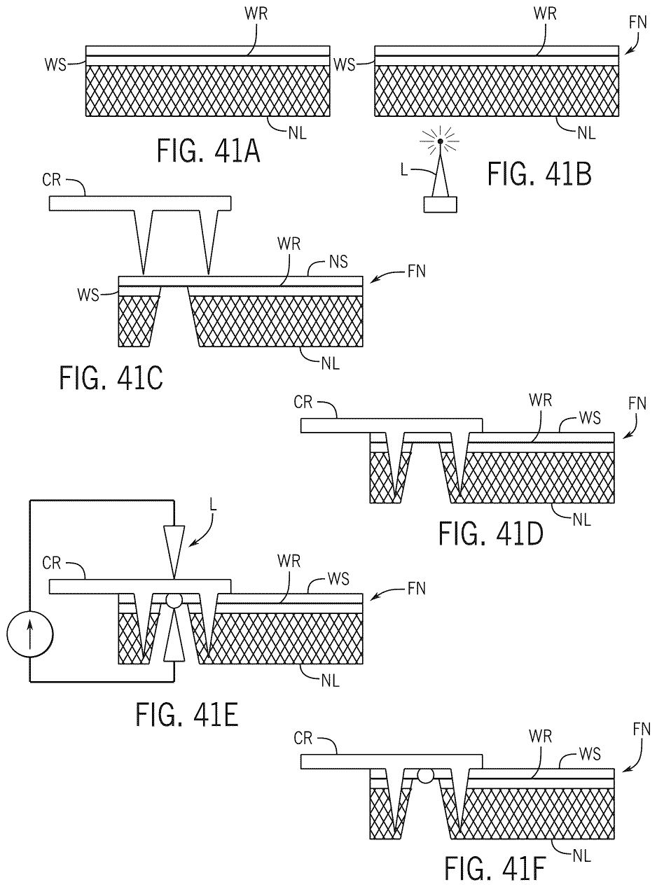

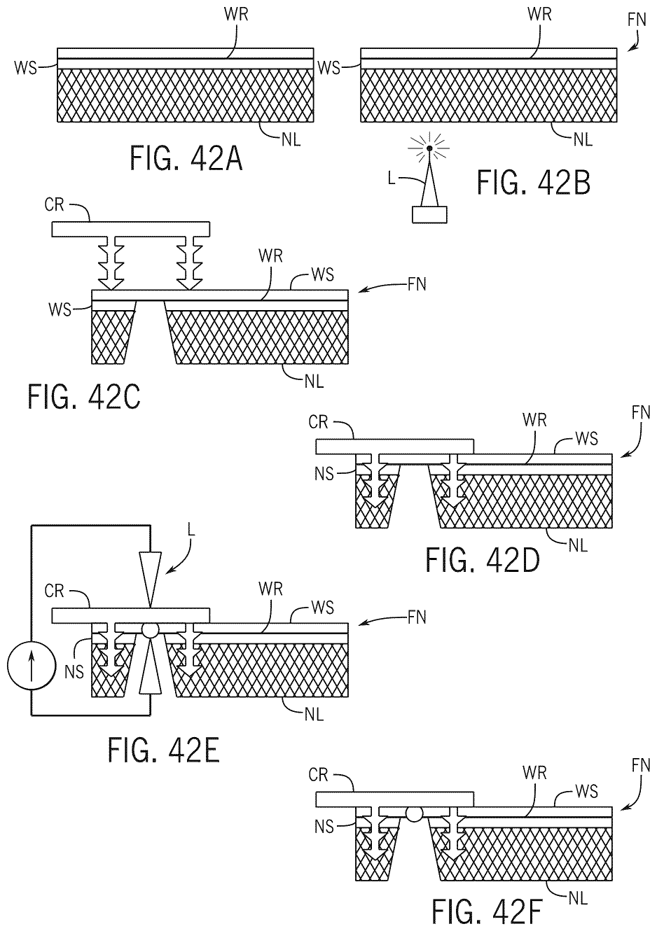

As indicated schematically according to an exemplary embodiment in FIGS. 2A-2D, 3A-3D, 4A-4D, 5A-5D, 13A-13E, 14A-14C, 21A-21D, 22A-22D, 23A-23G, 24A-24E, 25A-25F, 26A-26C, 27A-27F, 28, 28A-28B, 29A-29E, 30A-30B, 34A-34G, 35A-35E, 36A-36D and 37A-37C, interface NT/CN for the component shown as steering wheel/assembly SW may comprise a mechanical interface configured to provide a mechanical connection for segments SG of composite structure CS and an electrical interface configured to provide an electrical connector CR/WRx for segments of functional insert FN of composite structure CS (see FIGS. 3A-3D, 4A-4D, 5A-5D, 13A-13E, 14A-14C, 21A-21D, 22A-22D, 23A-23G, 24A-24E, 25A-25F, 26A-26C, 27A-27F, 28, 28A-28B, 29A-29E, 30A-30B, 34A-34G, 40A-40G, 41A-41F, 42A-42F); as indicated schematically, interface NT/CN may comprise a combined/integrated mechanical/electrical connector such as a bridge BR (with mechanical connection BRm and electrical connection BRe/TM) for segments of the component/assembly (see FIGS. 24A-24E, 25A-25F, 26A-26C, 34A-34G, 37A-37C, 38A-38F, 39A-39G, 40A-40G); interface NT/CN may comprise a connector arrangement comprising a plug PG and socket PT configured to provide a mechanical/electrical connection for segments of the component/assembly (see FIGS. 3A-3D, 4A-4D, 5A-5D, 35A-35E, 36A-36D); interface NT/CN may comprise a connector arrangement comprising a rigid/flexible wire connector BRe/WRx configured to provide an electrical connection at a mechanical connection for segments of the component/assembly (see FIGS. 25A-25F, 26A-26C, 27A-27F, 28, 28A-28B, 29A-29E, 30A-30B, 34A-34G); interface NT/CN may comprise a connector arrangement comprising a connector CR configured to provide a mechanical/electrical connection for segments of the component/assembly (see FIGS. 3A-3D, 4A-4D, 5A-5D, 27A-27F, 28, 28A-28B, 29A-29E, 30A-30B, 34A-34G, 35A-35E, 36A-36D, 37A-37C); interface NT/CN may comprise a connector arrangement comprising an insulation displacement connector (IDC) arrangement providing a connector CR configured to provide a mechanical/electrical connection for segments of the component/assembly (see FIGS. 2A-2D, 3A-3D, 4A-4D, 5A-5D, 29A-29E); interface NT/CN may comprise a connector arrangement comprising a metal-to-metal connection of a terminal TM for connector CR and with a connector/plate FNc the functional insert FN configured to provide a press-fit mechanical/electrical connection for segments of the component/assembly (see FIGS. 34A-34G, 38A-38F, 39A-39G, 40A-40G, 41A-41F, 42A-42F); at interface NT/CN a connector/arrangement such as with connector CR may be configured to fit and/or to be retained within a seat/position GR (e.g. for connector plate of connector CR) within a segment SG of the component/assembly (see FIGS. 30A-30B, 34A-34G). See also FIGS. 9A-9B, 10A-10B, 11A-11E, 12A-12B, 19A-19B, 20A-20D, 23A-23G, 24A-24E, 25A-25F and 26A-26C.

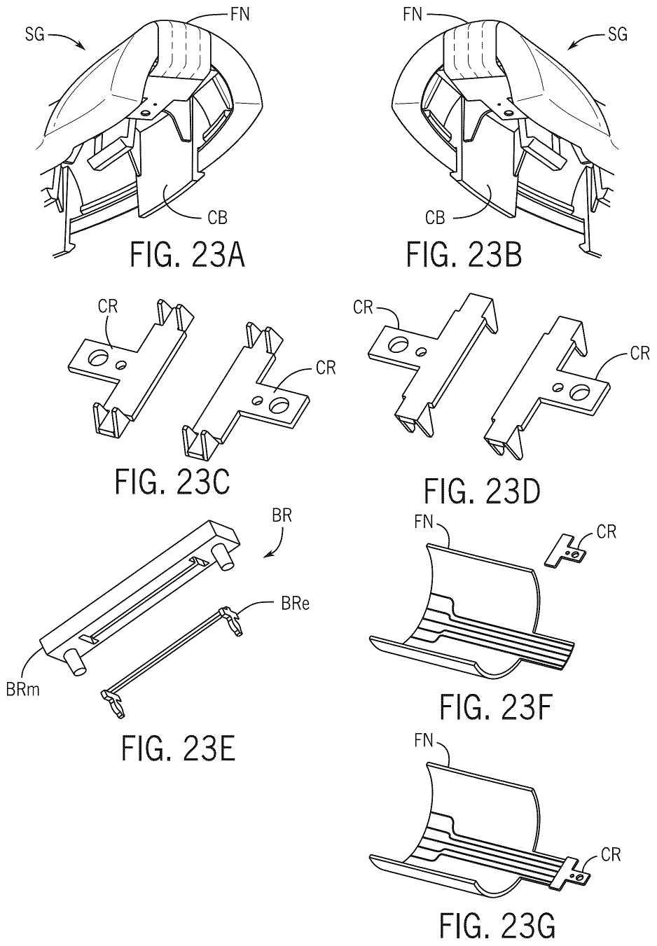

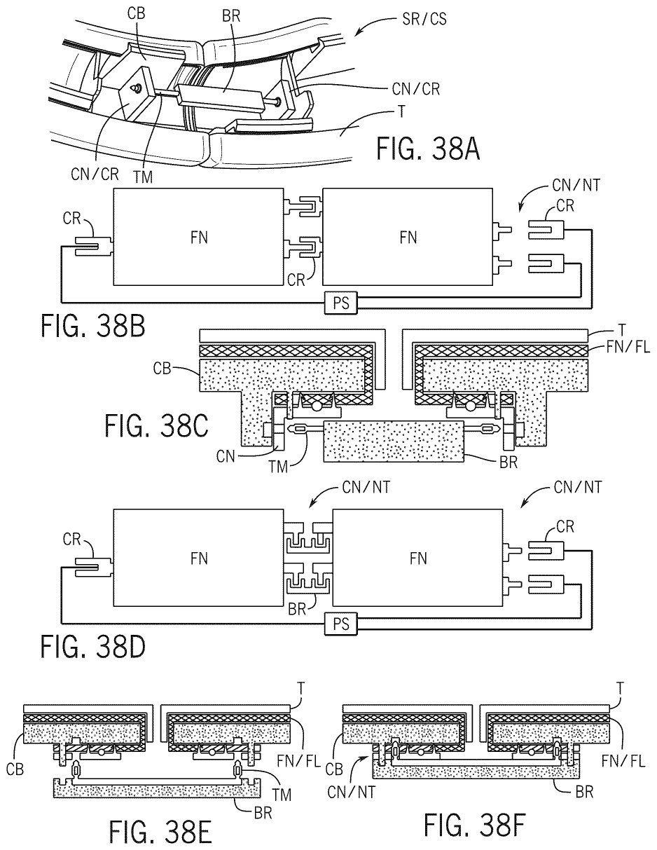

As indicated schematically according to an exemplary embodiment FIGS. 2A-2D, 3A-3D, 4A-4D, 5A-5D, 27A-27F, 28, 28A-28B, 29A-29E, 30A-30B, 34A-34G, 35A-35E, 36A-36D and 37A-37C, interface NT for component/assembly C of composite structure CS may be configured to provide mechanical alignment of shell segments SG and electrical connection of the functional insert segments of functional insert/layer FN/FL. See also FIGS. 38A-38F, 39A-39G, 40A-40G, 41A-41F and 42A-42F. As indicated schematically in FIGS. 6A-6F, 7A-7F, 31A-31B, 32A-32D, 33A-33C, 38A-38F, 39A-39G, 40A-40G, 41A-41F and 42A-42F, functional insert FN of composite structure CS of component C shown as steering wheel assembly SW may comprise a heating element WR/HT and/or a sensor WR/SN and/or an electrified functional insert FN configured to provide a functional circuit (e.g. an integrated functional circuit configured for connection at an interface NT comprising connectors CR, etc.). See FIGS. 23F, 23G, 24C, 24E, 31A-31B, 32A-32D, 33A-33C and 34A. As indicated schematically according to an exemplary embodiment in FIGS. 2A-2D, 3A-3B, 4A-4B, 5A-5D, 27A-27F, 28, 28A-28B, 29A-29E, 30A-30B, 34A-34G, 35A-35E, 36A-36D and 37A-37C, functional insert FN may comprise a set of functional insert segments configured to be mechanically connected and electrically connected at a connector CR provided at interface NT/CN.

According to an exemplary embodiment as shown schematically in FIGS. 2A-2D, 8A-8B, 9A-9B, 10A-10B, 11A-11E, 12A-12B, 13A-13E, 14A-14C, 15A-15D, 16A-16D, 17A-17D, 18A-18D and 36A-36D, segments SG of rim/composite structure SR/CS of steering wheel assembly SW may comprise functional insert/layer FN/FL and an intermediate layer NL shown as a spacer material and a substrate/carrier/base layer SB/CB with a cover T comprising a cover layer TX; as indicated schematically, engagement elements may be provided within composite structure CS (e.g. as a projection and retainer/recess for a fitting connection, such as a snap-fit connection of segments); as indicated schematically, composite structure CS for rim SR on frame RM may comprise segments SG configured for engagement at an engagement portion shown as comprising engagement elements to engage to retain segment/sections and onto frame structure RM; segments SG may comprise a positioning/alignment section comprising elements (e.g. plurality of elements arranged for the segment/shell section) and a carrier/base layer CB with a cover T; as indicated schematically, positioning elements may be provided within composite structure CS to facilitate placement/location of segment/shell sections SG during assembly onto frame structure RM; as indicated schematically, the positioning/alignment elements may provide structure for retaining the segments of functional insert FN and to provide a space/pathway for interface NT and other elements including connectors CT/CR, wires/cables WRx to be connected/installed within the rim and/or between segments of the rim (e.g. such as for connectivity with functional segments, functional modules, functional layers, etc. to controller/control system, vehicle systems, etc.). See also FIGS. 2A-2D, 3A-3D, 4A-4D, 5A-5D, 20A-20D, 21A-21D, 22A-22D, 23A-23G, 24A-24E, 25A-25F, 26A-26C. 27A-27F, 28, 28A-28B, 29A-29E and 30A-30B.

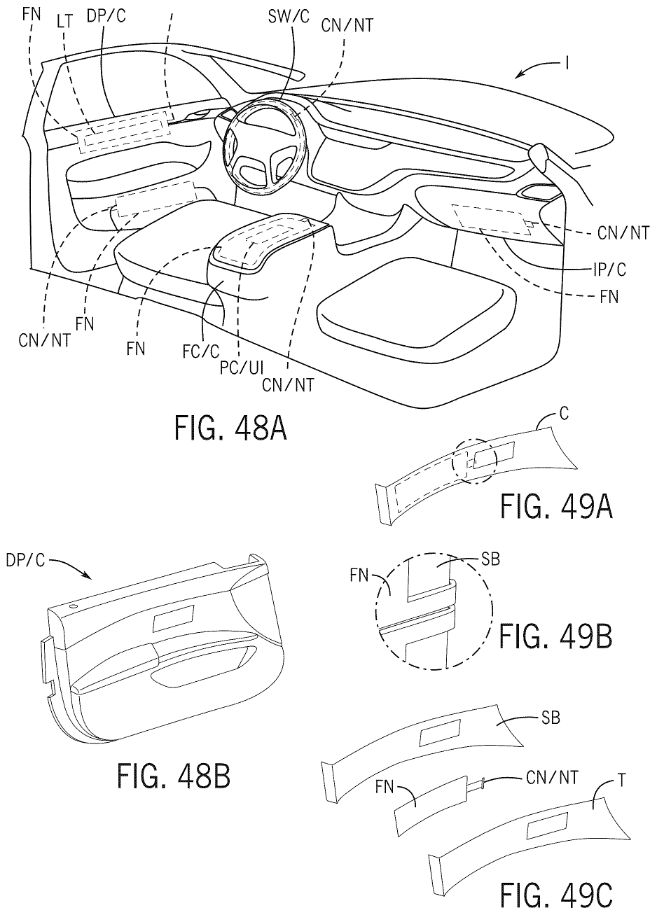

As indicated schematically in FIGS. 2A-2D, 3A-3D, 4A-4D, 5A-5D, 20A-20D, 21A-21D, 22A-22D, 23A-23G, 24A-24E, 25A-25F, 26A-26C, 27A-27F, 28, 28A-28B, 29A-29E and 30A-30B, component C such as steering wheel SW may comprise a controller/control module CM in base SB with a rim SR comprising segments shown as functional segments SG (e.g. segments with functional layer/module) such as a hands-off sensor WR/SN/HOD or an integrated arrangement of hands-off sensor WR/HOD with heating element WR/HT or a transducer or sensor SN or lighting elements such as light source/LED light LT and/or a power charging system PC. See also FIGS. 48A-48B and 49A-49C (schematical representation of integration of components with functional insert FN and interface/connection NT/CN).

As indicated schematically in FIGS. 3A-3D, 4A-4D, 5A-5D, 20A-20D, 21A-21D, 22A-22D, 23A-23G, 24A-24E, 25A-25F, 26A-26C, 27A-27F, 28, 28A-28B, 29A-29E and 30A-30B, composite structure CS for segments SG of rim SR such as cover/shell segments SG and with segments of substrate/carrier SB/CB and segments of functional insert FN comprising the functional circuit/system (e.g. configured to be electrified/operated, calibrated, etc. with functional module FM and/or control module CM) shown such as an integrated hands-off sensor SN/HOD and heating element HT (e.g. mat with heating wire arrangement) may be connected at an interface NT by a connector arrangement CN comprising a connector elements CR/BR positioned for establishing mechanical/electrical connectivity within the segment/rim and/or connector elements PG/PT positioned for establishing mechanical/electrical connectivity at center section CX of the component shown as steering wheel assembly SW. See also FIGS. 2A-2D, 8A-8B, 9A-9B, 10A-10B, 11A-11E, 12A-12B, 13A-13E, 14A-14C, 15A-15D, 16A-16D, 17A-17D, 18A-18D and 31A-31B.

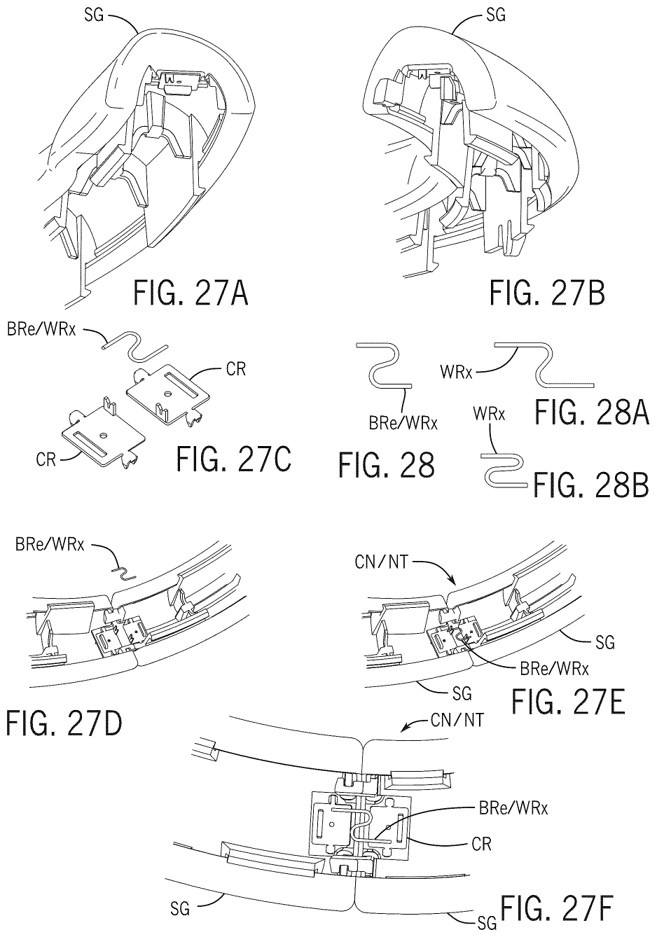

According to an exemplary embodiment as shown schematically in FIGS. 2A-2D, 3A-3D, 4A-4D, 5A-5D, 9A-9B, 10A-10B, 11A-11E, 12A-12B, 13A-13E, 14A-14C, 19A-19B, 20A-20D, 21A-21D, 22A-22D, 23A-23G, 24A-24E, 25A-25F and 26A-26C, component C for a vehicle interior such as a steering wheel assembly SW may comprise a frame RM and a composite structure CS configured to be assembled to frame RM; composite structure CS may comprise a cover T and a functional insert FN; composite structure CS may comprise an interface NT for each functional insert FN; interface NT may comprise an electrical interface and a mechanical interface for the functional insert; the interface may comprise a combined interface/connector NT/CN comprising the electrical interface and the mechanical interface for functional insert FN; interface NT may comprise an integrated connector comprising the electrical interface and the mechanical interface for functional insert FN; the electrical interface may be configured to provide an electrical connection CN/CR; the electrical interface may comprise an electrical connector CN/CR; functional insert FN may be configured to be electrified; functional insert FN may be configured to provide a functional circuit; functional insert FN may comprise a set of functional insert segments configured to be mechanically connected and electrically connected at a connector CR provided at interface NT; interface NT may comprise a self-aligning mechanical connection CR/BR; each functional insert segment may be configured to be connected at a segment interface NT/CN; segment interface NT/CN may comprise an integrated connector CR/GR comprising a mechanical interface and an electrical interface for functional insert segment FN; interface NT may comprise a mechanical connection comprising a plastic member at a bridge BR and/or a base; interface NT may comprise a self-aligning mechanical connection comprising a member such as a plastic member BRm and an electrical connection such as a connector member with terminals BRe/TM for a bridge BR and a base CR and/or a self-aligning mechanical connection comprising a plug PG and a socket PT; interface NT may comprise a self-aligning mechanical connection comprising a plug PG and a socket PT configured to align adjacent composite structure segments and/or sections. See also FIGS. 27A-27F, 28, 28A-28B, 29A-29E, 30A-30B, 34A-34G, 35A-35E, 36A-36D, 37A-37C, 38A-38F, 39A-39G, 40A-40G, 41A-41F and 42A-42F.

According to an exemplary embodiment as shown schematically in FIGS. 3A-3D, 4A-4D, 5A-5D, 19A-19B, 20A-20D, 21A-21D, 22A-22D, 23A-23G, 24A-24E, 25A-25F, 26A-26C, 27A-27F, 28, 28A-28B, 29A-29E, 30A-30B, 34A-34G, 35A-35E, 36A-36D and 37A-37C, the rim with composite structure CS/SR may comprise a set of cover segments of cover T and a set of functional insert segments of functional insert FN; the functional insert segment of the functional insert FN may be provided within a cover segment SG of cover T; interface/connector NT/CN with connector CR or bridge BR may be provided at seat/position GR in cover segment SG; interface NT may comprise a connector CN/CR configured to retain an electrical connection between adjacent functional insert segments during misalignment, twisting, etc. of adjacent cover segments; the connector for the interface may comprise a wire, a bridge, an S-shaped wire element, a flexible S-shaped wire element, a bendable S-shaped wire element, a twistable S-shaped wire element, etc.

According to an exemplary embodiment as shown schematically in FIGS. 9A-9B, 10A-10B, 11A-11E, 12A-12B, 13A-13E, 14A-14C, 19A-19B, 20A-20D, 21A-21D, 22A-22D, 23A-23G, 24A-24E, 25A-25F and 26A-26C, composite structure CS of the assembly/component C may comprise cover T and a base and/or a substrate SB/CB for functional layer FL of functional insert FN; substrate SB of composite structure CS may comprise a carrier CB; carrier SB/CB may comprise a set of carrier segments, a plastic material, a rigid material, a rigid plastic material, a structural substrate, a panel, etc.

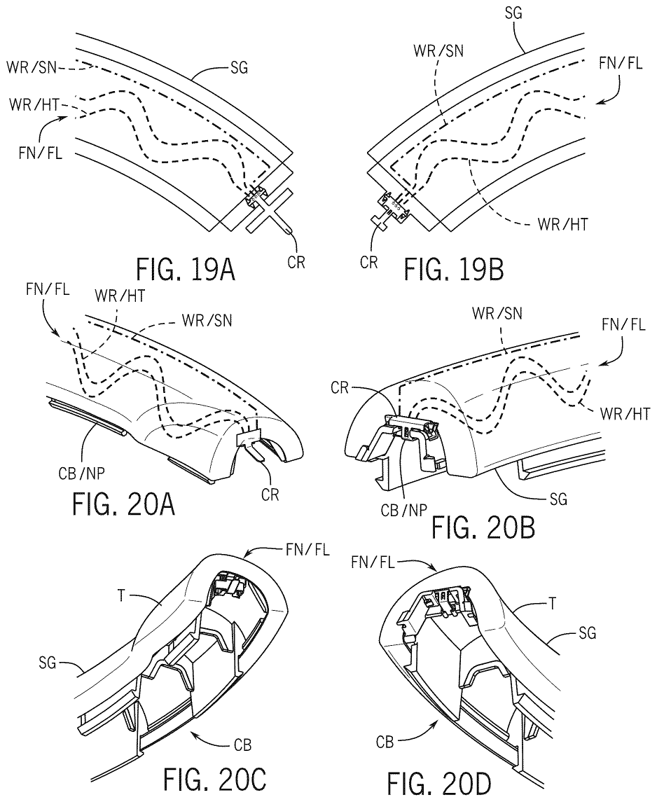

According to an exemplary embodiment as indicated schematically in FIGS. 2A-2D, 8A-8B, 9A-9B, 10A-10B, 11A-11E, 12A-12B, 13A-13E, 14A-14C, 15A-15D, 16A-16D, 17A-17D and 18A-18D, the cover of the composite structure for the assembly/component may comprise a set of cover segments comprising a cover material; the cover material may comprise at least one of a resin, a plastic, a film, leather, synthetic leather, a fabric, a textile, a cork material, a sustainable leather alternative material, a molded cover material, a wrap, a wrappable material, a drapable material, a flexible cover material, etc.; the cover may be configured to fit over the functional insert (e.g. within a gap, etc.); a cover segment may comprise at least one of a recess for a connector for the interface, a projection for a connector for the interface, a surface for a connector for the interface, a mount for a connector for the interface, a seat for a connector base of a connector for the interface, etc. See also FIGS. 19A-19B, 20A-20D, 21A-21D, 22A-22D, 23A-23G, 24A-24E, 25A-25F, 26A-26C, 27A-27F, 28, 28A-28B, 29A-29E, 30A-30B, 34A-34G, 35A-35E, 36A-36D and 37A-37C.

According to an exemplary embodiment as shown schematically in FIGS. 1B, 2A-2D, 3A-3D, 4A-4D, 5A-5D, 6A-6F, 7A-7F, 8A-8B, 48A-48B and 49A-49C, a component C for a vehicle interior comprising a composite structure CS on a base/substrate SB with a cover T and functional insert FN and interface NT with integrated electrical/mechanical connection CN may comprise a steering wheel assembly SW/C, a door panel DP/C, an instrument panel IP/C, a console FC/C or other trim panel/component assembly; the component may comprise a substrate such as with base/frame a composite structure configured to be assembled to the substrate and base/frame; the composite structure may comprise a cover T for functional insert FN/FL and interface/connector NT/CN for each segment for functional insert FN; interface NT may comprise an electrical interface and a mechanical interface; interface NT may comprise a combined/integrated interface/connector CN comprising the electrical interface/connector and the mechanical interface/connector; the mechanical interface may be configured to provide a mechanical connection for the composite structure; the electrical interface may be configured to provide an electrical connector for the composite structure; the cover may comprise a set of cover/shell segments SG; functional insert FN may comprise a set of functional insert segments; composite structure CS may comprise a set of composite structure segments comprising cover segments T and functional insert segments FN; interface NT may be configured to provide mechanical alignment of shell segments SG and electrical connection of the functional insert segments FN; functional insert FN may comprise a heating element HT and/or a sensor SN/HOD and/or an electrified functional insert configured to provide a functional circuit; functional insert FN may comprise a set of functional insert segments configured to be mechanically connected and electrically connected at a connector CN/CR provided at interface NT. See also FIGS. 9A-9B, 10A-10B, 11A-11E, 12A-12B, 13A-13E, 14A-14C, 19A-19B, 20A-20D, 21A-21D, 22A-22D, 23A-23G, 24A-24E, 25A-25F and 26A-26C.

As indicated schematically according to an exemplary embodiment in FIGS. 31A-31B, 32A-32D, 33A-33C, the functional circuit provided by functional insert FN may comprise functional elements such as a heating element HT and a sensor/detector SN with a switch ST (shown as a MOSFET/transistor switch) and a power source PS; each segment of functional insert FN may comprise the interface NT/CN for interconnection with the composite structure CS of the component C shown as steering wheel SW, etc.; the functional circuit provided by functional insert/layer FN/FL may be operated by a functional module FM and/or control module CM. See also FIGS. 2A-2D, 14A-14C, 48A-48B and 49A-49C.

As indicated schematically according to an exemplary embodiment in FIGS. 9A-9B, 10A-10B, 11A-11E, 12A-12B, 13A-13E, 14A-14C, 19A-19B, 20A-20D, 21A-21D, 22A-22D, 23A-23G, 24A-24E, 25A-25F and 26A-26C, the integrated/combined efficient connection at the interface NT for component C may comprise a connection CN such as at least one of a connector, a metal connector, a terminal, a plug, a socket for a plug, a plug for a socket, a plug and a socket, a conductor, a conductor plate, a metal plate, a metal terminal to metal plate connection, an IDC connection, a bridge connector, a mechanical/electrical bridge, a rigid wire/cable, a plastic connector. See also FIGS. 27A-27F, 28, 28A-28B, 29A-29E, 30A-30B, 34A-34G, 35A-35E, 36A-36D, 37A-37C, 38A-38F, 39A-39G, 40A-40G, 41A-41F and 42A-42F.

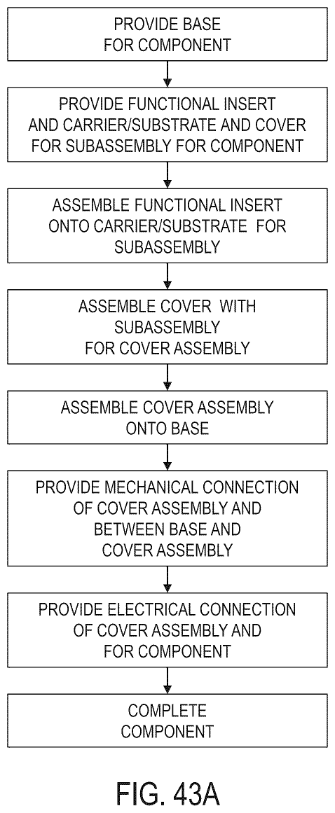

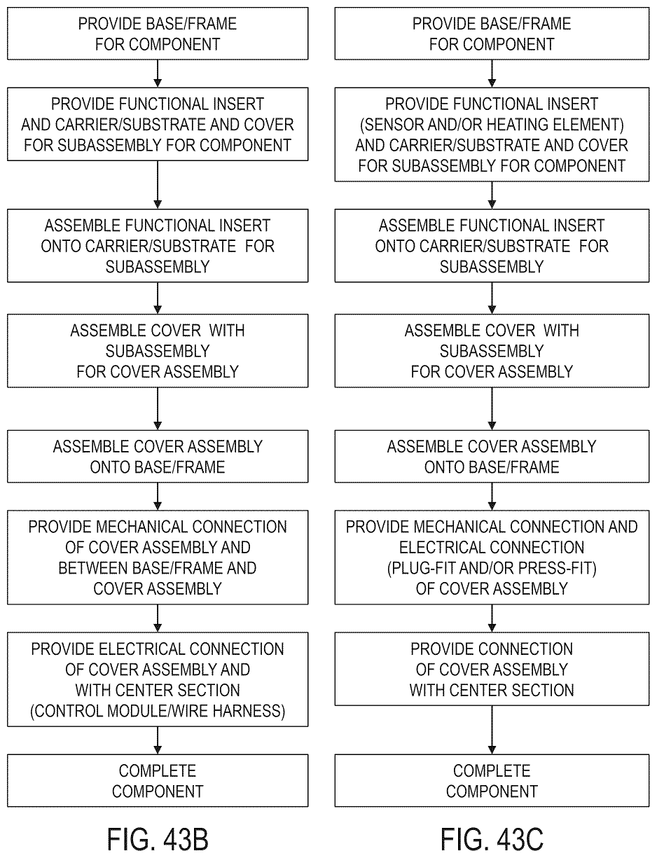

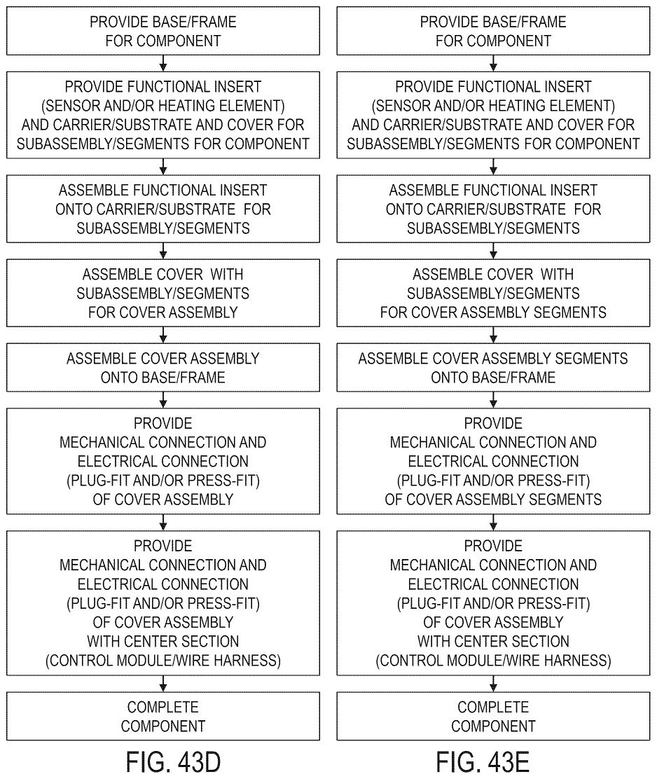

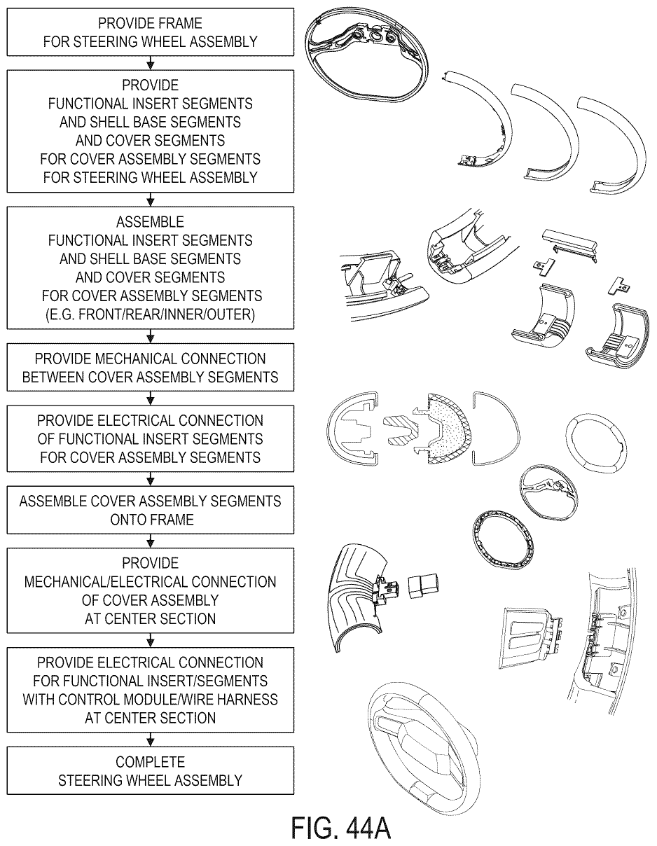

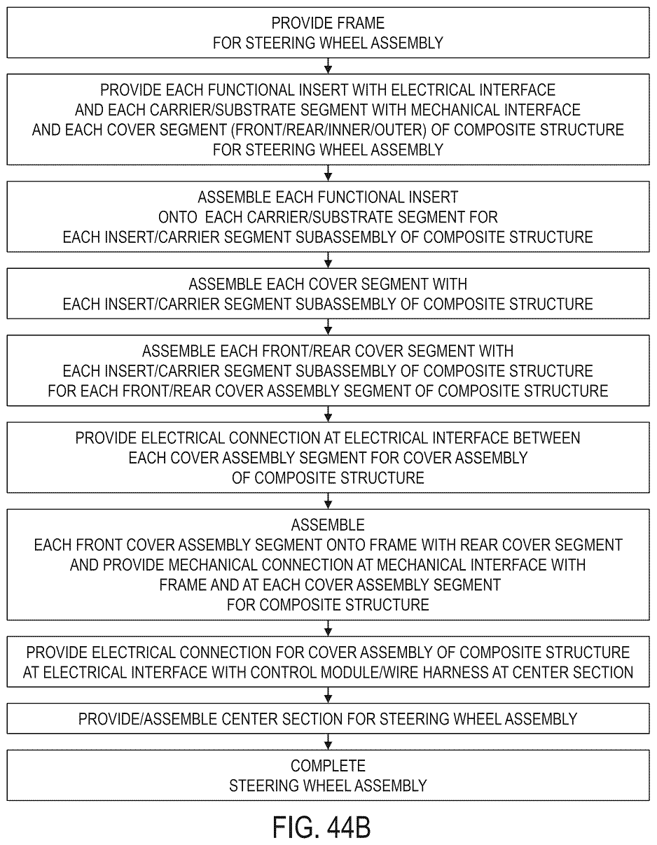

As indicated schematically according to an exemplary embodiment in FIGS. 43A-43E and 44A-44B, a method of manufacturing/assembly of a component/steering wheel may be provided; the method may comprise assembly of segments/sections of the component with a set of steps intended to be configured/arranged to provide for improved efficiency in the manufacturing/assembly operation, including efficient/integrated electrical/mechanical connection of segments/sections of the assembly. As indicated schematically in FIGS. 2A-2D, 3A-3D, 4A-4D, 5A-5D, 27A-27F, 28, 28A-28B, 29A-29E, 30A-30B, 34A-34G, 35A-35E, 36A-36D and 37A-37C, the method may comprise assembly of the composite structure CS for the rim SR comprising segments SG to assembly a cover T and a substrate SB/CB with a functional insert/layer FN/FL that are connected at an interface NT/CN to provide for mechanical and/or electrical connection; the method may comprise assembly with improved efficiency in the manufacturing/assembly operation by use of efficient/integrated electrical/mechanical connection CN at the interface NT with a connector CR/BR and/or terminal TM and conductor/plate FNc at the interface NT/CN between segments SG. See also FIGS. 38A-38F, 39A-39G, 40A-40G, 41A-41F and 42A-42F.

As indicated schematically according to an exemplary embodiment in FIGS. 34A-34G, 37A-37C, 38A-38F, 39A-39G, 40A-40G, 41A-41F and 42A-42F, the composite structure CS may comprise a functional insert FN; the functional insert FN may comprise a set of functional insert segments configured to be mechanically connected and electrically connected at a press-fit connector provided at the interface NT; the functional insert FN may comprise a set of functional insert segments configured to be mechanically connected and electrically connected at a metal-to-metal press-fit connector CR with terminal TM provided at the interface NT; the metal-to-metal press-fit connector may comprise a metal sheet/connector FNc. See also FIGS. 23A-23G, 31A-31B.

### Method of Assembly/Manufacturing

As indicated schematically according to an exemplary embodiment in FIGS. 34A-34G, 43A-43E and 44A-44B, a method of manufacturing/assembly of a component/steering wheel comprising a composite structure comprising segments for a cover T and substrate SB/CB with a functional insert/layer FN/FL comprising segments may comprise a set of steps intended to be configured/arranged for improved efficiency in the manufacturing/assembly operation, including efficient/integrated electrical/mechanical connection with a connector CR/BR and/or terminal TM and conductor/plate FNc at the interface NT/CN between segments SG. See also FIGS. 38A-38F, 39A-39G, 40A-40G, 41A-41F and 42A-42F.

As shown schematically according to an exemplary embodiment in FIG. 43A, a method of manufacturing a component/steering wheel for a vehicle interior may comprise providing a base for the component, providing a functional insert and carrier/substrate and cover for a subassembly for the component, assembling the functional insert onto the carrier/substrate for the subassembly, assembling a cover with the subassembly for a cover assembly; assembling the cover assembly onto the base; providing a mechanical connection of the cover assembly between the base and the cover assembly; providing an electrical connection of the cover assembly for the component, and completing the component.

As shown schematically according to an exemplary embodiment in FIG. 43B, a method of manufacturing a component/steering wheel for a vehicle interior may comprise providing a base/frame for the component, providing a functional insert and carrier/substrate and cover for a subassembly for component, assembling the functional insert onto a carrier/substrate for the subassembly, assembling a cover with the subassembly for a cover assembly, assembling the cover assembly onto the base/frame, providing a mechanical connection of the cover assembly between the base/frame and cover assembly, providing an electrical connection of the cover assembly with a center section (control module/wire harness), and completing the component.

As shown schematically according to an exemplary embodiment in FIG. 43C, a method of manufacturing a component/steering wheel for a vehicle interior may comprise providing a base/frame for the component, providing a functional insert (sensor and/or heating element) and a carrier/substrate and a cover for a subassembly for the component, assembling the functional insert onto the carrier/substrate for the subassembly, assembling the cover with the subassembly for a cover assembly, assembling the cover assembly onto the base/frame, providing a mechanical connection and an electrical connection (plug-fit and/or press-fit) of the cover assembly, providing a connection of the cover assembly with a center section, and completing the component.

As shown schematically according to an exemplary embodiment in FIG. 43D, a method of manufacturing a component/steering wheel for a vehicle interior may comprise providing a base/frame for the component, providing a functional insert (sensor and/or heating element) and a carrier/substrate and a cover for a subassembly/segments for the component, assembling the functional insert onto the carrier/substrate for the subassembly/segments, assembling the cover with the subassembly/segments for a cover assembly, assembling the cover assembly onto the base/frame, providing a mechanical connection and an electrical connection (plug-fit and/or press-fit) of the cover assembly, providing a mechanical connection and an electrical connection (plug-fit and/or press-fit) of the cover assembly with a center section (control module/wire harness), and completing the component.

As shown schematically according to an exemplary embodiment in FIG. 43E, a method of manufacturing a component/steering wheel for a vehicle interior may comprise providing a base/frame for the component, providing a functional insert (sensor and/or heating element) and a carrier/substrate and a cover for a subassembly/segments for the component, assembling the functional insert onto the carrier/substrate for the subassembly/segments, assembling the cover with the subassembly/segments for cover assembly segments, assembling the cover assembly segments onto the base/frame, providing a mechanical connection and an electrical connection (plug-fit and/or press-fit) of the cover assembly segments, providing a mechanical connection and an electrical connection (plug-fit and/or press-fit) of the cover assembly with a center section (control module/wire harness), and completing the component.

As shown schematically according to an exemplary embodiment in FIG. 44A, a method of manufacturing a component/steering wheel assembly for a vehicle interior may comprise providing a frame for the steering wheel assembly, providing functional insert segments and shell base segments and cover segments for cover assembly segments for the steering wheel assembly, assembling the functional insert segments and shell base segments and cover segments for the cover assembly segments (e.g. front/rear/inner/outer), providing a mechanical connection between the cover assembly segments, providing an electrical connection of the functional insert segments for the cover assembly segments, assembling the cover assembly segments onto the frame, providing a mechanical/electrical connection of the cover assembly at a center section, providing an electrical connection for the functional insert/segments with a control module/wire harness at the center section, and completing the steering wheel assembly.

As shown schematically according to an exemplary embodiment in FIG. 44B, a method of manufacturing a component/steering wheel assembly for a vehicle interior may comprise providing a frame for the steering wheel assembly, providing each functional insert with an electrical interface and each carrier/substrate segment with a mechanical interface and each cover segment (front/rear/inner/outer) of a composite structure for the steering wheel assembly, assembling each functional insert onto each carrier/substrate segment for each insert/carrier segment subassembly of the composite structure, assembling each cover segment with each insert/carrier segment subassembly of the composite structure, assembling each front/rear cover segment with each insert/carrier segment subassembly of the composite structure for each front/rear cover assembly segment of the composite structure, providing an electrical connection at an electrical interface between each cover assembly segment for a cover assembly of the composite structure, assembling each front cover assembly segment onto the frame with a rear cover segment and providing a mechanical connection at a mechanical interface with the frame and at each cover assembly segment for the composite structure, providing an electrical connection for a cover assembly of the composite structure at an electrical interface with a control module/wire harness at a center section, providing/assembling the center section for the steering wheel assembly, and completing the steering wheel assembly.

### Exemplary Embodiments—A

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert.

As shown schematically according to an exemplary embodiment in the FIGURES, the interface may comprise an electrical interface and a mechanical interface for the functional insert. The interface may comprise a combined interface comprising the electrical interface and the mechanical interface for the functional insert. The interface may comprise an integrated connector comprising the electrical interface and the mechanical interface for the functional insert. The electrical interface may be configured to provide an electrical connection; the electrical interface may comprise an electrical connector. The mechanical interface may be configured to provide a mechanical connection; the mechanical interface may comprise a mechanical connector.

As shown schematically according to an exemplary embodiment in the FIGURES, the cover may comprise a set of cover segments. The set of cover segments may comprise a set of shell segments. The functional inserts may comprise a set of functional insert segments. The composite structure may comprise a set of composite structure segments. The composite structure may comprise a set of composite structure segments comprising the set of cover segments and the set of functional insert segments. The composite structure may comprise a set of composite structure segments comprising the set of shell segments and the set of functional insert segments.

As shown schematically according to an exemplary embodiment in the FIGURES, the interface may be configured to provide mechanical alignment of the set of shell segments and electrical connection of the functional insert segments. The interface may comprise a combined interface for mechanical alignment and electrical connection. The electrical connection may comprise a connector. The functional insert may comprise a heating element and/or a sensor. The functional insert may be configured to provide an electrified functional insert; the electrified functional insert may be configured to provide a functional circuit. The functional insert may comprise a set of functional insert segments configured to be mechanically connected and electrically connected at a connector provided at the interface. The functional insert may comprise a set of functional insert segments configured to be mechanically connected and electrically connected at a connector comprising a wire connection provided at the interface. The functional insert may comprise a set of functional insert segments configured to be mechanically connected and electrically connected at a press-fit connector provided at the interface. The functional insert may comprise a set of functional insert segments configured to be mechanically connected and electrically connected at a combined connector provided at the interface. The functional insert may comprise a set of functional insert segments configured to be mechanically connected and electrically connected at an integrated connector provided at the interface. The functional insert may comprise a set of functional insert segments configured to be mechanically connected and electrically connected at an integrated mechanical/electrical connector provided at the interface. The composite structure may comprise a set of composite structure segments; each composite structure segment may comprise a functional insert segment. The functional insert may comprise a set of functional insert segments.

As shown schematically according to an exemplary embodiment in the FIGURES, the composite structure may be configured to be assembled on the frame. The cover may comprise a set of cover segments. The component may comprise a center section configured to be assembled on the frame; the center section may comprise a controller; the controller may comprise a control system for the functional insert. The functional insert may be connected to the controller at an interface. The frame may comprise an armature and a center frame; the center frame may comprise at least one spoke. The composite structure may be configured to be assembled on the armature of the frame.

As shown schematically according to an exemplary embodiment in the FIGURES, the interface may be configured to connect each functional insert. Each functional insert segment may comprise a functional circuit. Each functional insert segment may be configured to be connected at an interface. Each functional insert segment may be configured to be connected at a segment interface; the segment interface may comprise an integrated connector comprising a mechanical interface and an electrical interface for the functional insert segment. The interface may comprise the segment interface. Each functional insert segment may be configured to be connected at the interface. The segment interface may comprise the mechanical interface and the electrical interface. The segment interface may comprise a connector. The interface may comprise at least one of (a) a connector; (b) a metal connector; (c) a terminal; (d) a plug; (e) a socket for a plug; (f) a plug for a socket; (g) a plug and a socket. The interface may comprise a mechanical connector. The mechanical connector may comprise an electrical interface. The interface may comprise (a) a bridge and a base; (b) an electrical connection at the bridge and a base; and (c) a mechanical connection at the bridge and a base. The interface may comprise a mechanical connection comprising a plastic member at a bridge and a base. The interface may comprise a self-aligning mechanical connection comprising a plastic member at a bridge and a base. The interface may comprise at least one of (a) a press-fit electrical interface; (b) a press-fit electrical connector; (c) a plug-in electrical interface; (d) a plug-in electrical connector; (e) a plug-socket electrical interface; (f) a plug-socket electrical connector. The interface may comprise an electrical interface. The interface may comprise an electrical connector. The electrical interface may comprise an electrical connector. The electrical interface may comprise a connector.

As shown schematically according to an exemplary embodiment in the FIGURES, the connector may comprise a bridge; the bridge may comprise a conductor. The connector may comprise a flexible element. The flexible element may comprise at least one of (a) a wire; (b) a rigid flexible wire; (c) a cable; (d) a semi-rigid wire; (e) a generally S-shaped element; (f) a generally S-shaped wire. The wire may comprise an insulated wire fit into a connector. The wire may comprise at least one of (a) a flexible insulated wire configured to fit into a connector base; (b) a semi-rigid flexible insulated wire configured to fit into a connector base; (c) a semi-rigid flexible insulated wire configured to fit at each end into a connector base; (d) a semi-rigid flexible insulated wire configured to fit at each end into a slot in a connector base; (e) a semi-rigid flexible insulated wire configured to fit at each end into a slot in a connector base to form an electrical connection for the interface. The connector may comprise an insulation displacement connector (IDC). The connector may comprise a connector integrated with the functional insert.

As shown schematically according to an exemplary embodiment in the FIGURES, the connector may comprise a connector base. The connector may be configured to be coupled to a functional insert segment. The connector may comprise a connector base configured to be assembled into a shell segment of the composite structure. The connector may comprise a connector base comprising projections configured to be assembled into a shell segment of the composite structure. The shell segment may comprise a base section for the connector base of the connector. The connector may comprise a base. The base may comprise a plate. The base may comprise a connector element. The connector may comprise at least one of (a) a connector element; (b) a set of connectors; (c) a jumper; (d) an extension. The connector may be configured to connect to a functional insert segment of the functional insert. The connector may be configured to connect from a functional insert segment of the functional insert. The connector may be configured to connect between a functional insert segment of the functional insert. The component may comprise a mechanical connector. The mechanical connector may comprise a bridge. The mechanical connector may comprise the electrical interface.

As shown schematically according to an exemplary embodiment in the FIGURES, the functional insert may be connected to a controller at an electrical interface. The functional insert may comprise a heating element. The functional insert may comprise a sensor. The functional insert may comprise a switch. The functional insert may comprise a functional circuit. The functional circuit may comprise a sensor, a hands-off sensor, and/or a hands-on sensor. The sensor may comprise a detector. The sensor may comprise a capacitive sensor. The heating element may comprise a resistor element. The functional circuit may comprise a switch; the switch may comprise a transistor; the transistor may comprise a MOSFET. The functional insert may comprise a functional layer. The functional insert may comprise a functional circuit. The functional insert may comprise at least one of (a) a layer, (b) a mat, (c) a film, (d) a foil, (e) a molded material, (f) a single layer material, (g) a multi-layer material, (h) a fabric material, (i) a set of wires, (j) a set of wires in a molded material, (k) a set of sections. The functional insert may comprise a material that is at least one of a flexible material, a drapable material, a wrappable material, an insert comprising wires, an insert comprising copper wires, an insert comprising fabric, a printed circuit, a flexible circuit, a flexible circuit, a flexible panel, a panel, a circuit comprising stitched wires, a film, a foam, a fabric.

As shown schematically according to an exemplary embodiment in the FIGURES, the functional insert may comprise a connector. The functional insert may comprise a connector for the electrical interface. The functional insert may comprise a connector for the mechanical interface. The functional insert may comprise a set of functional insert segments. A functional insert segment may comprise a functional circuit with a connector. A functional insert segment may comprise a combined interface with a connector for the electrical interface and for the mechanical interface. A functional insert segment may comprise a functional circuit with a connector for the interface.

As shown schematically according to an exemplary embodiment in the FIGURES, the composite structure may comprise a set of cover segments of the cover and a set of functional insert segments of the functional insert; a functional insert segment of the functional insert may be provided within a cover segment of the cover; the interface may comprise a connector configured to retain an electrical connection to the functional insert segment during misalignment of a cover segment. The composite structure may comprise a set of cover segments of the cover and a set of functional insert segments of the functional insert; a functional insert segment of the functional insert may be provided within a cover segment of the cover; the interface may comprise a connector configured to retain an electrical connection between functional insert segments during misalignment of cover segments. The composite structure may comprise a set of cover segments of the cover and a set of functional insert segments of the functional insert; a functional insert segment of the functional insert may be provided within a cover segment of the cover; the interface may comprise a connector configured to retain an electrical connection between adjacent functional insert segments during misalignment of adjacent cover segments. The connector may comprise at least one of (a) a wire, (b) a bridge, (c) an S-shaped wire element, (d) a flexible S-shaped wire element, (e) a bendable S-shaped wire element, (f) a twistable S-shaped wire element.

As shown schematically according to an exemplary embodiment in the FIGURES, the cover may comprise a set of cover segments; the set of cover segments may comprise a set of shell segments. The set of cover segments may comprise a set of front segments and a set of rear segments. The set of cover segments may comprise a set of outer segments and a set of inner segments. The set of cover segments may comprise a set of 4 shell segments; the shell segments comprise 2 rear shell segments. The set of cover segments may comprise a set of 5 shell segments; the shell segments may comprise 2 outer shell segments and 3 inner shell segments. The set of cover segments may comprise a set of 8 shell segments; the shell segments comprise 4 rear shell segments. The cover may comprise a set of cover segments comprising a cover material; the cover material may comprise at least one of a resin, a plastic, a film, leather, synthetic leather, a molded cover material, a wrap, a wrappable material, a drapable material, a flexible cover material. The cover may be configured to fit over the functional insert. The set of cover segments may be configured to fit over a set of functional inserts. The set of cover segments may be configured to fit at an end into a gap between a set of functional inserts. A cover segment may comprise a mount for a connector for the interface. A cover segment may comprise at least one of (a) a recess for a connector for the interface, (b) a projection for a connector for the interface, (c) a surface for a connector for the interface. A cover segment may comprise a seat for a connector base of a connector for the interface. A connector base of the interface may be configured to fit within a section of a cover segment of the cover.

As shown schematically according to an exemplary embodiment in the FIGURES, the composite structure may comprise a substrate. The composite structure may comprise a substrate for a functional layer of the functional insert. The composite structure may comprise a carrier. The carrier may comprise at least one of (a) a set of carrier segments, (b) a plastic material, (c) a rigid material, (d) a rigid plastic material. The carrier may be configured to provide a base. The composite structure may comprise a base. The base may be configured to fit on the frame. The base may comprise at least one of (a) a substrate; (b) a carrier; (c) a carrier for the functional insert. The base may be configured to provide alignment for the functional insert.

As shown schematically according to an exemplary embodiment in the FIGURES, the composite structure may comprise an intermediate layer under the functional insert. The intermediate layer may comprise a set of segments configured on a set of carrier segments of a carrier of the composite structure. The intermediate layer may comprise a set of segments configured on a set of substrate segments of a substrate of the composite structure. The intermediate layer may comprise at least one of a spacer, a spacer fabric, a textile, a film, foam, a foam material, a multi-layer spacer, an insulating material, an insulator.

As shown schematically according to an exemplary embodiment in the FIGURES, the set of shell segments may comprise a set of shell sections configured to be fit in radial engagement around the frame. The frame may comprise a feature configured to facilitate axial alignment of a shell section of the set of shell sections on the frame. The frame may comprise a feature configured to facilitate radial engagement of a shell section of the set of shell sections on the frame. The set of shell sections may comprise a first section configured to be fit onto the frame and a second section configured to be fit with the first section. The set of shell segments may comprise a set of shell sections configured to fit together in radial engagement. The one shell segment may comprise a positioning element. The cover may comprise a cover layer; the cover layer may comprise a decorative layer. The cover layer may be configured to provide the visual effect and/or a tactile effect; the set of shell segments are configured to provide the visual effect; the visual effect may comprise a multi-segment appearance. The steering wheel assembly may comprise a rim; the rim may comprise a cover configured to provide an exterior surface and an intermediate layer under the cover; the intermediate layer may comprise at least one of a shell section and/or a soft material and/or a resilient material.

As shown schematically according to an exemplary embodiment in the FIGURES, a method of producing a component for a vehicle may comprise the steps of providing a frame, providing a composite structure comprising a cover and a functional insert to be assembled onto the frame, assembling the composite structure with the cover and the functional insert for the frame, and mechanically connecting and electrically connecting the functional insert at an interface. The interface may comprise a mechanical interface and/or an electrical interface for the functional insert. The interface may comprise an integrated interface comprising a mechanical interface and an electrical interface for the functional insert; mechanically connecting the functional insert may be simultaneous with electrically connecting the functional insert. The interface may comprise at least one of (a) a press-fit interface; (b) a press-fit connection; (c) a plug-in connection; (d) a bridge connection; (e) a wire connection. The component may comprise a steering wheel assembly. The method may comprise the steps of assembling the center section of the steering wheel assembly; connecting the functional insert to the center section; and electrically connecting the functional insert to the center section at a connector. The method may comprise the step of electrically connecting the functional insert to a control module in the center section. The interface may comprise a mechanical interface and an electrical interface for the functional insert. The cover may comprise a set of cover segments; the set of cover segments may comprise a set of shell segments; the functional inserts may comprise a set of functional insert segments; the composite structure may comprise a set of composite structure segments comprising the set of cover segments and the set of functional insert segments. The interface may be configured to provide mechanical alignment of the set of shell segments and electrical connection of the functional insert segments; the interface may comprise a combined interface for mechanical alignment and electrical connection. The functional insert may comprise a set of functional insert segments configured to be mechanically connected and electrically connected at a connector comprising (a) a wire connection provided at the interface or (b) a press-fit connector provided at the interface or (c) a combined connector provided at the interface or (d) an integrated connector provided at the interface or (e) an integrated mechanical/electrical connector provided at the interface or (f) a self-aligning mechanical connector provided at the interface or (g) a flexible electrical connector provided at the interface.

As shown schematically according to an exemplary embodiment in the FIGURES, a component for a vehicle interior comprising a base and a composite structure configured to be assembled to the base. The composite structure may comprise a cover and a functional insert. The composite structure may comprise an interface for each functional insert. The interface may comprise a mechanical interface and an electrical interface for the functional insert. The base may comprise a substrate for at least one of vehicle trim, a trim panel, a door panel, and instrument panel. The component may comprise at least one of a vehicle trim, a trim panel, a door panel, an instrument panel, a floor console. The interface may be configured to provide simultaneously an electrical connection and a mechanical connection.

### Exemplary Embodiments—B

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert. The interface may comprise a mechanical interface and/or an electrical interface for the functional insert.

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert. The interface may comprise a mechanical interface and an electrical interface for the functional insert.

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert. The interface may comprise a mechanical interface or an electrical interface for the functional insert.

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert.

As shown schematically according to an exemplary embodiment in the FIGURES, the interface may comprise an electrical interface and a mechanical interface for the functional insert. The interface may comprise a combined interface comprising the electrical interface and the mechanical interface for the functional insert. The interface may comprise an integrated interface comprising the electrical interface and the mechanical interface for the functional insert. The interface may comprise an integrated connector comprising the electrical interface and the mechanical interface for the functional insert. The electrical interface may be configured to provide an electrical connection. The electrical interface may comprise an electrical connector. The mechanical interface may be configured to provide a mechanical connection. The mechanical interface may comprise a mechanical connector.

As shown schematically according to an exemplary embodiment in the FIGURES, the cover may comprise a set of cover segments. The set of cover segments may comprise a set of shell segments. The functional inserts may comprise a set of functional insert segments. The composite structure may comprise a set of composite structure segments. The composite structure may comprise a set of composite structure segments comprising the set of cover segments and the set of functional insert segments. The composite structure may comprise a set of composite structure segments comprising the set of shell segments and the set of functional insert segments. The interface may be configured to provide mechanical alignment of the set of shell segments and electrical connection of the functional insert segments. The interface may comprise a combined interface for mechanical alignment and electrical connection. The electrical connection may comprise a connector. The interface may comprise a space-saving interface.

As shown schematically according to an exemplary embodiment in the FIGURES, the functional insert may comprise a heating element and/or a sensor. The functional insert may comprise electronic features. The functional insert may be configured to provide an electrified functional insert. The electrified functional insert may be configured to provide a functional circuit. The functional insert may be configured to be mechanically connected and electrically connected at a connector provided at the interface. The functional insert may comprise a set of functional insert segments configured to be mechanically connected and electrically connected at a connector provided at the interface. The functional insert may comprise a set of functional insert segments configured to be mechanically connected and electrically connected at a connector comprising a wire connection provided at the interface. The functional insert may comprise a set of functional insert segments configured to be mechanically connected and electrically connected at a press-fit connector provided at the interface. The functional insert may comprise a set of functional insert segments configured to be mechanically connected and electrically connected at a combined connector provided at the interface. The functional insert may comprise a set of functional insert segments configured to be mechanically connected and electrically connected at an integrated connector provided at the interface. The functional insert may comprise a set of functional insert segments configured to be mechanically connected and electrically connected at an integrated mechanical/electrical connector provided at the interface. The functional insert may comprise a set of functional insert segments configured to be mechanically connected and electrically connected at an integrated mechanical/electrical connector provided at the interface.

As shown schematically according to an exemplary embodiment in the FIGURES, the composite structure may comprise a set of composite structure segments. Each composite structure segment may comprise a functional insert segment. The functional insert may comprise a functional insert segment. The functional insert may comprise a set of functional insert segments. The functional insert may comprise a set of functional insert sections. The composite structure may comprise a carrier. The functional insert may be on the carrier. The functional insert may be assembled on the carrier. The composite structure may comprise a cover. The cover may be on the functional insert. The functional insert may be assembled into the cover. The composite structure configured to be assembled on the frame. The cover may comprise a set of cover segments.

As shown schematically according to an exemplary embodiment in the FIGURES, the component/assembly may comprise a center section configured to be assembled on the frame. The center section may comprise a controller. The functional insert may be connected to the controller. The controller may comprise a control system. The controller may comprise a control system for the functional insert. The functional insert may be connected to the controller at an interface. The frame may comprise a center frame. The center frame may comprise at least one spoke. The frame may comprise an armature. The composite structure may be configured to be assembled on the armature of the frame. The set of segments may comprise a set of shell segments configured to be assembled in axial alignment on the frame.

As shown schematically according to an exemplary embodiment in the FIGURES, the interface may be configured to connect each functional insert. The functional insert may comprise a set of functional insert segments. The component may comprise an interface configured to connect a functional insert segment to an adjacent functional insert segment. Each functional insert segment may comprise a functional circuit. Each functional insert segment may be configured to be connected at an interface. Each functional insert segment may be configured to be connected at a segment interface. The segment interface may comprise an integrated connector comprising a mechanical interface and an electrical interface for the functional insert segment. The interface may comprise the segment interface. Each functional insert segment may be configured to be connected at the interface. The segment interface may comprise a mechanical interface. The segment interface may comprise an electrical interface. The segment interface may comprise a mechanical interface and an electrical interface. The segment interface may comprise a connector. The interface may comprise a connector. The interface may comprise a metal connector. The interface may comprise a terminal. The interface may comprise a plug. The interface may comprise a socket for a plug. The interface may comprise a plug for a socket. The interface may comprise a plug and a socket. The interface may comprise a mechanical connector. The mechanical connector may comprise a bridge. The mechanical connector may comprise a mechanical interface. The mechanical connector may comprise an electrical interface. The interface may comprise a bridge and a base. The interface may comprise an electrical connection at a bridge and a base. The interface may comprise a mechanical connection at a bridge and a base. The interface may comprise an electrical connection comprising a metal connector at a bridge and a base.

As shown schematically according to an exemplary embodiment in the FIGURES, the interface may comprise a mechanical connection comprising a plastic member at a bridge and a base. The interface may comprise a self-aligning mechanical connection comprising a plastic member at a bridge and a base. The interface may comprise a press-fit electrical interface. The interface may comprise a press-fit electrical connector. The interface may comprise a plug-in electrical interface. The interface may comprise a plug-in electrical connector. The interface may comprise a plug-socket electrical interface. The interface may comprise a plug-socket electrical connector. The interface may comprise an electrical interface. The interface may comprise an electrical connector. The electrical interface may comprise an electrical connector. The electrical interface may comprise a connector. The connector may comprise a bridge. The connector may comprise a wire. The connector may comprise a cable. The connector may comprise a bridge. The bridge may comprise a wire. The bridge may comprise a cable. The bridge may comprise a conductor. The connector may comprise a flexible element. The flexible element may comprise a wire. The flexible element may comprise a rigid flexible wire. The flexible element may comprise a cable. The flexible element may comprise a semi-rigid wire. The flexible element may comprise a generally S-shaped element. The flexible element may comprise a generally S-shaped wire. The wire may comprise an insulated wire. The wire may comprise an insulated wire fit into a connector. The wire may comprise an insulated wire fit into a connector base. The wire may comprise a flexible insulated wire configured to fit into a connector base. The wire may comprise a semi-rigid flexible insulated wire configured to fit into a connector base. The wire may comprise a semi-rigid flexible insulated wire configured to fit at each end into a connector base. The wire may comprise a semi-rigid flexible insulated wire configured to fit at each end into a slot in a connector base. The wire may comprise a semi-rigid flexible insulated wire configured to fit at each end into a slot in a connector base to form an electrical connection for the interface. The connector may comprise an IDC connector. The connector may comprise a connector integrated with the functional insert.

As shown schematically according to an exemplary embodiment in the FIGURES, the connector may comprise a connector base. The connector may be configured to be coupled to a functional insert segment. The connector may comprise a connector base configured to be assembled to a shell segment of the composite structure. The connector may comprise a connector base configured to be assembled into a shell segment of the composite structure. The connector may comprise a connector base comprising projections configured to be assembled into a shell segment of the composite structure. The shell segment may comprise a base section for the connector base of the connector. The base section for the connector base of the connector may comprise a recess. The connector may comprise a base. The base may comprise a plate. The base may comprise a connector element. The connector may comprise a connector element. The connector may comprise a set of connectors. The connector may comprise a jumper. The connector may comprise an extension. The connector may extend from a functional insert segment of the functional insert. The connector may extend into a functional insert segment of the functional insert. The connector may be configured to connect to a functional insert segment of the functional insert. The connector may be configured to connect from a functional insert segment of the functional insert. The connector may be configured to connect between a functional insert segment of the functional insert. The component/assembly may comprise a mechanical connector. The mechanical connector may comprise a bridge. The mechanical connector may comprise the electrical interface.

As shown schematically according to an exemplary embodiment in the FIGURES, the functional insert may be connected to the controller at an electrical interface. The functional insert may comprise a heating element. The functional insert may comprise a sensor. The functional insert may comprise a switch. The functional insert may comprise a functional circuit. The functional circuit may comprise a heating element. The functional circuit may comprise a sensor. The sensor may comprise a hands-off sensor. The sensor may comprise a hands-on sensor. The sensor may comprise a detector. The sensor may comprise a capacitive sensor. The heating element may comprise a resistor. The heating element may comprise a resistor element. The functional circuit may comprise a switch. The switch may comprise a transistor. The transistor may comprise a MOSFET. The functional insert may comprise a layer. The functional insert may comprise a functional layer. The functional insert may comprise a functional circuit. The functional insert may comprise a mat. The functional insert may comprise a film. The functional insert may comprise a foil. The functional insert may comprise a molded material. The functional insert may comprise a single layer material. The functional insert may comprise a multi-layer material. The functional insert may comprise a fabric material. The functional insert may comprise a set of wires. The functional insert may comprise a set of wires in a molded material. The functional insert may comprise a set of sections. The functional insert may comprise a material that is at least one of a flexible material, a drapable material, a wrappable material, an insert comprising wires, an insert comprising copper wires, an insert comprising fabric, a printed circuit, a flexible circuit, a flexible circuit, a flexible panel, a panel, a circuit comprising stitched wires, a film, a foam, a fabric. The functional insert may comprise a connector. The connector may comprise connection for the electrical interface. The functional insert may comprise a connector for the electrical interface. The connector may comprise connection for the mechanical interface. The functional insert may comprise a connector for the mechanical interface.

As shown schematically according to an exemplary embodiment in the FIGURES, the functional insert may comprise a set of functional insert segments. A functional insert segment may comprise a functional circuit with a connector. A functional insert segment may comprise a combined interface with a connector for the electrical interface and for the mechanical interface. A functional insert segment may comprise a functional circuit with a connector for the interface. A functional insert segment may comprise a functional circuit with a connector for the electrical interface. A functional insert segment may comprise a functional circuit with a connector for the mechanical interface. The composite structure may comprise a set of cover segments of the cover and a set of functional insert segments of the functional insert; a functional insert segment of the functional insert may be provided within a cover segment of the cover; the interface may comprise a connector configured to retain an electrical connection to the functional insert segment during misalignment of a cover segment. The composite structure may comprise a set of cover segments of the cover and a set of functional insert segments of the functional insert; a functional insert segment of the functional insert may be provided within a cover segment of the cover; the interface may comprise a connector configured to retain an electrical connection between functional insert segments during misalignment of cover segments. The composite structure may comprise a set of cover segments of the cover and a set of functional insert segments of the functional insert; a functional insert segment of the functional insert may be provided within a cover segment of the cover; the interface may comprise a connector configured to retain an electrical connection between adjacent functional insert segments during misalignment of adjacent cover segments. The connector may comprise a wire. The connector may comprise a bridge. The connector may comprise an S-shaped wire element. The connector may comprise a flexible S-shaped wire element. The connector may comprise a bendable S-shaped wire element. The connector may comprise a twistable S-shaped wire element

As shown schematically according to an exemplary embodiment in the FIGURES, the composite structure may comprise a set of cover segments of the cover and a set of functional insert segments of the functional insert; a functional insert segment of the functional insert may be provided within a cover segment of the cover; the interface may comprise a connector configured to retain an electrical connection between adjacent functional insert segments during twisting misalignment of adjacent cover segments.

As shown schematically according to an exemplary embodiment in the FIGURES, the cover may comprise a set of cover segments. The set of cover segments may comprise a set of shell segments. The set of cover segments may comprise a set of front segments and a set of rear segments. The set of cover segments may comprise a set of outer segments and a set of inner segments. The cover may comprise a set of cover segments. The set of cover segments may comprise a set of at least 4 shell segments. The set of cover segments may comprise a set of 4 shell segments. The set of cover segments may comprise a set of 5 shell segments. The set of cover segments may comprise a set of 6 shell segments. The set of cover segments may comprise a set of 8 shell segments. The set of cover segments may comprise a set of 4 shell segments; the shell segments comprise 2 rear shell segments. The set of cover segments may comprise a set of 5 shell segments; the shell segments comprise 2 front shell segments. The set of cover segments may comprise a set of 5 shell segments; the shell segments comprise 2 outer shell segments. The set of cover segments may comprise a set of 5 shell segments; the shell segments comprise 3 inner shell segments. The set of cover segments may comprise a set of 6 shell segments; the shell segments comprise 3 front shell segments. The set of cover segments may comprise a set of 8 shell segments; the shell segments comprise 4 rear shell segments. The cover may comprise a set of cover segments comprising a cover material. The cover material may comprise at least one of a resin, a plastic, a film, leather, synthetic leather, a molded cover material, a wrap, a wrappable material, a drapable material, a flexible cover material. The cover may be configured to fit over the functional insert. The set of cover segments may be configured to fit over a set of functional inserts. The set of cover segments may be configured to wrap over a set of functional inserts. The set of cover segments may be configured to wrap over a set of functional inserts at each end. The set of cover segments may be configured to fit into a gap between a set of functional inserts. The set of cover segments may be configured to fit at an end into a gap between a set of functional inserts. The set of cover segments may be configured to wrap into a gap between a set of functional inserts. The set of cover segments may be configured to fill a gap between a set of functional inserts. The set of cover segments may be configured to fill a gap at an end between a set of functional inserts. A cover segment may comprise a position for a connector for the interface. A cover segment may comprise a mount for a connector for the interface. A cover segment may comprise a recess for a connector for the interface. A cover segment may comprise a projection for a connector for the interface. A cover segment may comprise a surface for a connector for the interface. A cover segment may comprise a seat for a connector for the interface. A cover segment may comprise a seat for a connector base for the interface. A cover segment may comprise a seat for a connector base of a connector for the interface. A cover segment may comprise a compartment for a connector base for the interface. A cover segment may comprise a housing for a connector for the interface. A cover segment may comprise a housing for a connector base of a connector for the interface. A connector base of the interface may be configured to fit within a section of a cover segment of the cover.

As shown schematically according to an exemplary embodiment in the FIGURES, the composite structure may comprise a substrate. The composite structure may comprise a structural substrate. The composite structure may comprise a substrate for the functional insert. The composite structure may comprise a substrate for a functional layer of the functional insert. The composite structure may comprise a carrier. The composite structure may comprise a set of carrier segments. The carrier may comprise a set of carrier segments. The carrier may comprise a plastic material. The carrier may comprise a rigid material. The carrier may comprise a rigid plastic material. The carrier may be configured to provide a structural substrate. The carrier may be configured to provide a base. The composite structure may comprise a base. The base may be configured to fit on the frame. The base may comprise a substrate. The base may comprise a carrier. The base may comprise a carrier for the functional insert. The base may be configured to provide alignment for the functional insert. The interface for the functional insert may comprise a terminal; the terminal may be provided alignment by the base. The composite structure may comprise an intermediate layer. The composite structure may comprise an intermediate layer under the functional insert. The intermediate layer may comprise a set of segments. The intermediate layer may comprise a set of segments configured to fit under a set of cover segments of the cover. The intermediate layer may comprise a set of segments configured to fit under a set of functional insert segments of the functional insert. The intermediate layer may comprise a set of segments configured to on a set of carrier segments of a carrier of the composite structure. The intermediate layer may comprise a set of segments configured to on a set of substrate segments of a substrate of the composite structure. The intermediate layer may comprise at least one of a spacer, a spacer fabric, a textile, a film, foam, a foam material, a multi-layer spacer, an insulating material, an insulator.

As shown schematically according to an exemplary embodiment in the FIGURES, the set of shell segments may comprise a set of shell sections configured to be fit in radial engagement around the frame. The set of shell sections may comprise a shell section configured to be fit onto the frame. The frame may comprise a feature configured to facilitate axial alignment of a shell section of the set of shell sections on the frame. The frame may comprise a feature configured to facilitate radial engagement of a shell section of the set of shell sections on the frame. The feature of the frame may comprise an indentation configured to engage with a positioning element. The set of shell sections may comprise a front section and a rear section. The set of shell sections may comprise a first section configured to be fit onto the frame and a second section configured to be fit with the first section. The set of shell sections may comprise a first section comprising an engagement portion configured to be fit with the frame and a second section comprising an engagement portion configured to be fit with the first section. The set of segments may comprise at least one of a decorative segment and/or a functional segment. When the set of shell segments is assembled onto the frame an engagement portion of a first shell segment can be connected at an engagement portion of a second shell segment. When the set of shell segments is assembled onto the frame an engagement portion of a shell segment can be connected at a feature of the frame. The feature of the frame may comprise an indentation on the frame configured to facilitate axial alignment of a shell segment. The set of shell segments may comprise a set of shell sections configured to fit together in radial engagement. The set of shell segments may comprise a first segment and a second segment; the first segment may be different than the second segment. The at least one shell segment may comprise a positioning element. The composite structure may comprise a cover comprising a cover layer; the cover layer may comprise a decorative layer. The cover layer may be configured to provide the visual effect and/or a tactile effect. The set of shell segments are configured to provide the visual effect; the visual effect may comprise a multi-segment appearance. The steering wheel assembly may comprise a rim; the rim may comprise a cover configured to provide an exterior surface and an intermediate layer under the cover; the intermediate layer may comprise at least one of a shell section and/or a soft material and/or a resilient material.

As shown schematically according to an exemplary embodiment in the FIGURES, a method of producing a component for a vehicle interior may comprising a steering wheel assembly may comprise the steps of providing a frame, providing a composite structure comprising a cover and a functional insert to be assembled onto the frame, assembling the composite structure with the cover and the functional insert for the frame, and mechanically connecting and electrically connecting the functional insert at an interface. The interface may comprise a mechanical interface and/or an electrical interface for the functional insert. The interface may comprise an integrated interface comprising a mechanical interface and an electrical interface for the functional insert. Mechanically connecting the functional insert may be simultaneous with electrically connecting the functional insert. The interface may comprise a press-fit interface. The interface may comprise a press-fit connection. The interface may comprise a plug-in connection. The interface may comprise a bridge connection. The interface may comprise a wire connection. The component may comprise a steering wheel assembly. The method may comprise the step of assembling the center section of the steering wheel assembly. The method may comprise the step of connecting the functional insert to the center section. The method may comprise the step of electrically connecting the functional insert to the center section. The method may comprise the step of electrically connecting the functional insert to the center section at a connector. The method may comprise the step of electrically connecting the functional insert to the center section at a plug-in connector. The method may comprise the step of electrically connecting the functional insert to a control module in the center section. The composite structure may comprise an interface for each functional insert. The interface may comprise a mechanical interface and an electrical interface for the functional insert. The cover may comprise a set of cover segments. The set of cover segments may comprise a set of shell segments. The functional inserts may comprise a set of functional insert segments. The composite structure may comprise a set of composite structure segments comprising the set of cover segments and the set of functional insert segments. The interface may be configured to provide mechanical alignment of the set of shell segments and electrical connection of the functional insert segments. The interface may comprise a combined interface for mechanical alignment and electrical connection. The electrical connection may comprise a connector. The interface may comprise a plug-in connector. The functional insert may comprise a set of functional insert segments configured to be mechanically connected and electrically connected at a connector comprising (a) a wire connection provided at the interface or (b) a press-fit connector provided at the interface or (c) a combined connector provided at the interface or (d) an integrated connector provided at the interface or (e) an integrated mechanical/electrical connector provided at the interface or (f) a self-aligning mechanical connector provided at the interface or (g) a flexible electrical connector provided at the interface. The cover may comprise a set of cover segments. The set of cover segments may comprise a set of shell segments. The set of cover segments may comprise a set of front segments and a set of rear segments. The set of cover segments may comprise a set of shell segments.

As shown schematically according to an exemplary embodiment in the FIGURES, a component for a vehicle interior may comprise a base and a composite structure configured to be assembled to the base. The composite structure may comprise a cover and a functional insert. The composite structure may comprise an interface for each functional insert. The interface may comprise a mechanical interface and an electrical interface for the functional insert. The base may comprise a substrate. The base may comprise a substrate for at least one of vehicle trim, a trim panel, a door panel, and instrument panel. The base may comprise a base for a door panel. The component may comprise a vehicle trim, a trim panel, a door panel, an instrument panel a floor console. The base may comprise a substrate panel for vehicle trim and/or a door panel and/or an instrument panel. The interface may be configured to provide an electrical connection and a mechanical connection. The electrical interface may be configured to provide an electrical connection. The mechanical interface may be configured to provide a mechanical connection. The interface may be configured to provide simultaneously an electrical connection and a mechanical connection.

As shown schematically according to an exemplary embodiment in the FIGURES, a component for an interior of a vehicle comprising a composite structure may comprise a functional insert/lawyer and an intermediate layer and a carrier/substrate and a mechanical/electrical connector. The intermediate layer may comprise a conductive material, and the electrical connector may comprise a shape. The intermediate layer may comprise a soft material and conductive wires to provide an electrical function, e.g., hand-off detection or heating; functions may operate with a single wire solution in a multiplexed operation controlled by a microcontroller (of a control module) or may operate with a two-wire solution in a conventional operation (controlled by a control module). The soft intermediate layer may be pretreated and compressed before a connector is crimped to it and the electrical connection of the wire and the connector may be achieved by laser welding. The electrical connection of the connector to an adjacent electrical part or a vehicle system may be achieved by using a plug-in connection or if later disassembly is not required by using a press-fit connection.

### Exemplary Embodiments—C

As shown schematically according to an exemplary embodiment in the FIGURES, a component for a vehicle interior may comprise a steering wheel assembly comprising a frame and a composite structure configured to be assembled to the frame. The composite structure may comprise a cover and a functional insert. The composite structure may comprise an interface for each functional insert. The interface may comprise an electrical interface and a mechanical interface for the functional insert. The interface may comprise a combined interface comprising the electrical interface and the mechanical interface for the functional insert. The interface may comprise an integrated connector comprising the electrical interface and the mechanical interface for the functional insert. The electrical interface may be configured to provide an electrical connection; the electrical interface may comprise an electrical connector. The mechanical interface may be configured to provide a mechanical connection; the mechanical interface may comprise a mechanical connector. The cover may comprise a set of cover segments. Each cover segment of the set of cover segments may comprise a shell segment. The functional insert may comprise a set of functional insert segments. The composite structure may comprise a set of composite structure segments. The composite structure may comprise a set of composite structure segments comprising the set of cover segments and the set of functional insert segments. The composite structure may comprise a set of composite structure segments comprising the set of shell segments and the set of functional insert segments. The interface may be configured to provide mechanical alignment of the set of shell segments and electrical connection of the functional insert segments. The interface may comprise a combined interface for mechanical alignment and electrical connection. The electrical connection may comprise a connector. The functional insert may comprise at least one of a heating element or a sensor. The functional insert may be configured to be electrified; the functional insert may be configured to provide a functional circuit. The functional insert may comprise a set of functional insert segments configured to be mechanically connected and electrically connected at a connector provided at the interface. The functional insert may comprise a set of functional insert segments; the interface may be configured to be mechanically connected and electrically connected at a connector between functional inserts. The functional insert may comprise a set of functional insert segments configured to be mechanically connected and electrically connected at a connector comprising a wire connection provided at the interface. The functional insert may comprise a set of functional insert segments configured to be mechanically connected and electrically connected at a connector comprising a bridge connection provided at the interface. The functional insert may comprise a set of functional insert segments configured to be mechanically connected and electrically connected at a press-fit connector provided at the interface. The functional insert may comprise a set of functional insert segments configured to be mechanically connected and electrically connected at a metal-to-metal press-fit connector provided at the interface. The metal-to-metal press-fit connector may comprise a metal sheet. The functional insert may comprise a set of functional insert segments configured to be mechanically connected and electrically connected at a combined connector provided at the interface. The functional insert may comprise a set of functional insert segments configured to be mechanically connected and electrically connected at an integrated connector provided at the interface. The functional insert may comprise a set of functional insert segments configured to be mechanically connected and electrically connected at an integrated mechanical/electrical connector provided at the interface. The composite structure may comprise a set of composite structure segments; each composite structure segment may comprise a functional insert segment. The functional insert may comprise a set of functional insert segments. The functional insert may be connected to the controller at an interface. The interface may be configured to connect each functional insert segment. Each functional insert segment may be configured to be connected at a segment interface; the segment interface may comprise an integrated connector comprising a mechanical interface and an electrical interface for the functional insert segment. The interface may comprise the segment interface; the segment interface may comprise the mechanical interface and the electrical interface and a connector. The interface may comprise at least one of (a) a connector; (b) a metal connector; (c) a terminal; (d) a plug; (e) a socket for a plug; (f) a plug for a socket; (g) a plug and a socket; (h) a conductor; (j) a conductor plate; (k) a metal plate; (l) a plastic connector. The interface may comprise (a) a bridge and a base; (b) an electrical connection at the bridge and a base; and (c) a mechanical connection at the bridge and a base; (d) a mechanical connector; (e) an electrical connector; (f) a conductor. The mechanical connector may comprise an electrical interface; the electrical connector may comprise a mechanical interface. The interface may comprise a self-aligning mechanical connection. The interface may comprise a mechanical connection comprising a plastic member at a bridge and a base. The interface may comprise a self-aligning mechanical connection comprising a plastic member at a bridge and a base and/or a self-aligning mechanical connection comprising a plug and a socket. The interface may comprise a self-aligning mechanical connection comprising a plug and a socket configured to align adjacent composite structure segments. The interface may comprise at least one of (a) a press-fit electrical interface; (b) a press-fit electrical connector; (c) a plug electrical interface; (d) a plug electrical connector; (e) a plug-in electrical interface; (f) a plug-in electrical connector; (g) a plug-socket electrical interface; (h) a plug-socket electrical connector; (i) interference fit; (j) friction fit; and (k) force fit. The interface may comprise an electrical connector. The connector may comprise a bridge; the bridge may comprise a conductor. The connector may comprise a flexible element. The flexible element may comprise at least one of (a) a wire; (b) a rigid flexible wire; (c) a cable; (d) a semi-rigid wire; (e) a generally S-shaped element; (f) a generally S-shaped wire. The wire may comprise at least one of (a) a flexible insulated wire configured to fit into a connector base; (b) a semi-rigid flexible insulated wire configured to fit into a connector base; (c) a semi-rigid flexible insulated wire configured to fit at each end into a connector base; (d) a semi-rigid flexible insulated wire configured to fit at each end into a slot in a connector base; (e) a semi-rigid flexible insulated wire configured to fit at each end into a slot in a connector base to form an electrical connection for the interface; (f) an insulated wire fit into a connector comprising an insulation displacement connector (IDC). The connector may comprise a connector integrated with the functional insert. The connector may comprise a connector base. The connector may be configured to be coupled to a functional insert segment. The connector may comprise a connector base configured to be assembled to a shell segment of the composite structure. Each shell segment may comprise a base section for the connector base of the connector. The connector may comprise at least one of (a) a connector element; (b) a set of connectors; (c) a jumper; (d) an extension; (e) a plate. The connector may be configured to connect to a functional insert segment of the functional insert. The functional insert may comprise at least one of (a) a heating element; (b) a sensor; (c) a switch; (d) a functional circuit. The functional circuit may comprise a sensor; a hands-off sensor; and/or a hands-on sensor. The sensor may comprise a capacitive sensor. The functional circuit may comprise a switch; the switch may comprise a transistor; the transistor may comprise a metal-oxide-semiconductor field-effect transistor (MOSFET). The functional insert may comprise at least one of (a) a layer; (b) a mat; (c) a film; (d) a foil; (e) a molded material; (f) a single layer material; (g) a multi-layer material; (h) a fabric material; (i) a set of wires; (j) a set of wires in a molded material; (k) a set of sections. The functional insert may comprise a connector. The functional insert may comprise a set of functional insert segments. A functional insert segment may comprise a combined interface with a connector for the electrical interface and for the mechanical interface. The composite structure may comprise a set of cover segments of the cover and a set of functional insert segments of the functional insert; a functional insert segment of the functional insert may be provided within a cover segment of the cover; the interface may comprise a connector configured to retain an electrical connection between adjacent functional insert segments during misalignment of adjacent cover segments. The connector may comprise at least one of (a) a wire; (b) a bridge; (c) an S-shaped wire element; (d) a flexible S-shaped wire element; (e) a bendable S-shaped wire element; (f) a twistable S-shaped wire element. The cover may comprise a set of cover segments comprising a cover material; the cover material may comprise at least one of a resin, a plastic, a film, leather, synthetic leather, a fabric, a textile, a cork material, a sustainable leather alternative material, a molded cover material, a wrap, a wrappable material, a drapable material, a flexible cover material. The cover may be configured to fit over the functional insert. A cover segment may comprise at least one of (a) a recess for a connector for the interface; (b) a projection for a connector for the interface; (c) a surface for a connector for the interface; (d) a mount for a connector for the interface. A cover segment may comprise a seat for a connector base of a connector for the interface. The composite structure may comprise a base and/or a substrate for a functional layer of the functional insert. The composite structure may comprise a carrier; the carrier may comprise at least one of (a) a set of carrier segments; (b) a plastic material; (c) a rigid material; (d) a rigid plastic material. The base may be configured to provide alignment for the functional insert. The composite structure may comprise an intermediate layer under the functional insert. The intermediate layer may comprise a set of segments configured on a set of substrate segments of a substrate of the composite structure. The intermediate layer may comprise at least one of a spacer, a spacer fabric, a textile, a film, foam, a foam material, a multi-layer spacer, an insulating material, an insulator. The composite structure may comprise a set of shell segments; the set of shell segments may comprise a set of shell sections configured to be fit in radial engagement around the frame. The frame may comprise a feature configured to facilitate axial alignment of a shell section of the set of shell sections on the frame. The steering wheel assembly may comprise a rim; the rim may comprise a cover configured to provide an exterior surface and an intermediate layer under the cover; the intermediate layer may comprise at least one of a shell section and/or a soft material and/or a resilient material.

As shown schematically according to an exemplary embodiment in the FIGURES, a method of producing a component for a vehicle may comprise the steps of providing a frame, providing a composite structure comprising a cover and a functional insert to be assembled onto the frame, assembling the composite structure with the cover and the functional insert for the frame, and mechanically connecting and electrically connecting the functional insert at an interface. The interface may comprise at least one of a mechanical interface or an electrical interface for the functional insert. The interface may comprise an integrated interface comprising a mechanical interface and an electrical interface for the functional insert; mechanically connecting the functional insert may be simultaneous with electrically connecting the functional insert. The interface may be configured to provide mechanical alignment of the set of shell segments and electrical connection of the functional insert segments; the interface may comprise a combined interface for mechanical alignment and electrical connection.

As shown schematically according to an exemplary embodiment in the FIGURES, a component for a vehicle interior may comprise a base and a composite structure configured to be assembled to the base. The composite structure may comprise a cover and a functional insert. The composite structure may comprise an interface for the functional insert. The interface may comprise a mechanical interface and an electrical interface for the functional insert.

TABLE A
REFERENCE SYMBOL LIST

| REFERENCE | ELEMENT, PART |
|---|---|
| SYMBOL | OR COMPONENT |
| V | VEHICLE |
| I | INTERIOR |
| C | COMPONENT |
| DP | DOOR PANEL |
| FC | FLOOR CONSOLE/ASSEMBLY |
| IP | INSTRUMENT PANEL/ASSEMBLY |
| SW | STEERING WHEEL/ASSEMBLY |
| UI | USER INTERFACE (INPUT DEVICE |
| | AND/OR OUTPUT DEVICE) |
| ABM | AIRBAG MODULE |
| CM | CONTROLLER/CONTROL MODULE |
| CS | COMPOSITE STRUCTURE |
| CX | CENTER SECTION/COMPONENT |
| FM | FUNCTIONAL MODULE |
| PC | POWER CHARGER (WIRELESS |
| | CHARGING MAT) |
| PS | POWER SUPPLY/SOURCE |
| RM | ARMATURE/FRAME |
| SB | BASE/SUBSTRATE |
| | (COMPOSITE STRUCTURE, SEGMENT, |
| | CENTER SECTION, ETC.) |
| SK | SPOKE/STRUCTURE |
| SN | SENSOR/DETECTOR |
| SR | RIM (WITH COMPOSITE |
| | STRUCTURE, FRAME) |
| ST | SWITCH (SWITCH ELEMENT, |
| | TRANSISTOR SWITCH, ETC.) |
| T | COVER (COVER SEGMENTS) |
| CB | SHELL SEGMENT BASE |
| CBs | SHELL SEGMENT BASE SOFT |
| DL | DECORATIVE LAYER |
| FL | FUNCTIONAL LAYER (FUNCTIONAL INSERT) |
| FN | FUNCTIONAL INSERT (INSERT, |
| | LAYER, MAT, PAD, CORE, ETC. |
| | WITH FUNCTIONAL CIRCUIT/ |
| | WIRING, CONFIGURED FOR |
| | ELECTRIFICATION/OPERATION) |
| | (SENSOR, DETECTOR, HEATING |
| | ELEMENT, TRANSDUCER, POWER |
| | CHARGING, AUDIO, LIGHTING, |
| | DISPLAY, CONNECTIVITY, ETC.) |
| FNc | INTERFACE/CONNECTOR (FUNCTIONAL INSERT) |
| HOD | SENSOR (HANDS-OFF/ON |
| | DETECTION MAT, SENSOR MAT) |
| HT | HEATING ELEMENT |
| | (HEATING MAT, ETC.) |
| LG | TRADEMARK/LOGO |
| NL | INTERMEDIATE LAYER |
| | (SPACER/FOAM/FABRIC, ETC.) |
| NP | ENGAGEMENT MEMBER |
| | (FASTENING MEMBER) |
| SG | SHELL SEGMENT |
| | (SECTION/SUBASSEMBLY) |
| TX | COVER SURFACE (EXTERIOR) |
| BR | BRIDGE (CONNECTOR) |
| BRe | ELECTRICAL BRIDGE/TERMINAL |
| BRm | MECHANICAL BRIDGE |
| CR | CONNECTOR |
| NT | INTERFACE (ELECTRICAL, MECHANICAL, ETC.) |
| CN | CONNECTION (FOR INTERFACE) |
| GR | LOCATION/SEAT (RECEPTACLE, |
| | MOUNT, INDENTATION) |
| PG | PLUG (CONDUCTOR, CONNECTOR, ETC.) |
| PT | SOCKET (CONDUCTOR, CONNECTOR, ETC.) |
| TM | TERMINAL (CONDUCTOR, CONNECTOR, ETC.) |
| WR/WRx | WIRE (CONDUCTOR, CONNECTOR, ETC.) |
| WS | INSULATION (WIRE, WIRE CONNECTION) |
| LT | LIGHT (LED LIGHT, LIGHTING |
| | ELEMENT/PANEL, DISPLAY PANEL) |
| PC | POWER CHARGING SYSTEM |
| | (CHARGING AREA/MAT) |
| L | LASER TOOL/DRILLING TOOL |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A component for a vehicle interior comprising a steering wheel assembly comprising:
a frame; and
a composite structure configured to be assembled to the frame;
wherein the composite structure comprises a cover and an insert;
wherein the insert comprises a functional insert;
wherein the composite structure comprises an interface for each functional insert;
wherein the interface comprises an electrical interface and a mechanical interface for the functional insert;
wherein the composite structure comprises a set of composite structure segments;
wherein the interface is configured to provide mechanical alignment of the set of shell segments and electrical connection of the functional insert segments.

2. The component of claim 1 wherein the composite structure comprises a set of composite structure segments comprising the set of cover segments and the set of functional insert segments.

3. The component of claim 1 wherein the composite structure comprises a set of composite structure segments comprising the set of shell segments and the set of functional insert segments.

4. The component of claim 1 wherein the interface comprises a combined interface for mechanical alignment and electrical connection.

5. The component of claim 1 wherein the functional insert comprises a set of functional insert segments configured to be mechanically connected and electrically connected at a metal-to-metal press-fit connector provided at the interface.

6. The component of claim 1 wherein the interface comprises at least one of (a) a connector; (b) a metal connector; (c) a terminal; (d) a plug; (e) a socket for a plug; (f) a plug for a socket; (g) a plug and a socket; (h) a conductor; (i) a conductor plate; (j) a metal plate; (k) a plastic connector.

7. The component of claim 1 wherein the interface comprises (a) a bridge and a base; (b) an electrical connection at the bridge and a base; and (c) a mechanical connection at the bridge and a base; (d) a mechanical connector; (e) an electrical connector; (f) a conductor.

8. The component of claim 1 wherein the interface comprises a mechanical connector; wherein the mechanical connector comprises an electrical interface; wherein the electrical connector comprises a mechanical interface.

9. The component of claim 1 wherein the interface comprises a self-aligning mechanical connection comprising a plastic member at a bridge and a base and/or a self-aligning mechanical connection comprising a plug and a socket.

10. The component of claim 1 wherein the interface comprises a connector; wherein the connector comprises a bridge; wherein the bridge comprises a conductor.

11. The component of claim 1 wherein the interface comprises a connector; wherein the connector comprises a flexible element; wherein the flexible element comprises at least one of (a) a wire; (b) a rigid flexible wire; (c) a cable; (d) a semi-rigid wire; (e) a generally S-shaped element; (f) a generally S-shaped wire.

12. The component of claim 1 wherein the functional insert comprises at least one of (a) a heating element; (b) a sensor; (c) a switch; (d) a functional circuit.

13. The component of claim 1 wherein the interface comprises a connector; wherein the connector comprises at least one of (a) a wire; (b) a bridge; (c) an S-shaped wire element; (d) a flexible S-shaped wire element; (e) a bendable S-shaped wire element; (f) a twistable S-shaped wire element.

14. The component of claim 1 wherein the composite structure comprises a set of cover segments of the cover and a set of functional insert segments of the functional insert; wherein a functional insert segment of the functional insert is provided within a cover segment of the cover; wherein the interface comprises a connector configured to retain an electrical connection between adjacent functional insert segments during misalignment of adjacent cover segments.

15. The component of claim 14 wherein a cover segment comprises at least one of (a) a recess for a connector for the interface; (b) a projection for a connector for the interface; (c) a surface for a connector for the interface; (d) a mount for a connector for the interface.

16. The component of claim 1 wherein the composite structure comprises a carrier; wherein the carrier comprises at least one of (a) a set of carrier segments; (b) a plastic material; (c) a rigid material; (d) a rigid plastic material.

17. The component of claim 1 wherein the composite structure comprises a base configured to provide alignment for the functional insert.

18. A method of producing a component for a vehicle comprising the steps of:
providing a frame;
providing a composite structure comprising a cover and a functional insert to be assembled onto the frame;
assembling the composite structure with the cover and the functional insert for the frame; and
mechanically connecting and electrically connecting the functional insert at an interface;
wherein the interface comprises at least one of a mechanical interface or an electrical interface for the functional insert.

19. The method of claim 18 wherein the interface is configured to provide mechanical alignment of the set of shell segments and electrical connection of the functional insert segments; wherein the interface comprises a combined interface for mechanical alignment and electrical connection.

20. A component for a vehicle interior comprising:
a base;
a composite structure configured to be assembled to the base;
wherein the composite structure comprises a cover and a functional insert;
wherein the composite structure comprises an interface for the functional insert;
wherein the interface comprises a mechanical interface and an electrical interface for the functional insert.
